(19) United States
(12) Patent Application Publication
(10) Pub. No.: US 2026/0355661 A1
(43) Pub. Date: Nov. 12, 2026

(54) FILTER MEDIA FOR PARTICULATE AND CHEMICAL FILTRATION

(71) Applicant: Donaldson Company, Inc., Bloomington, MN (US)

(72) Inventors: Daniel M. Tefera, Bloomington, MN (US); Colton J. Halla, Minneapolis, MN (US); Alexander E. Mottet, Carver, MN (US); Dustin Zastera, Hastings, MN (US)

(21) Appl. No.: 19/672,395

(22) Filed: May 8, 2026

Related U.S. Application Data
(60) Provisional application No. 63/803,239, filed on May 9, 2025.
(60) Provisional application No. 64/000,746, filed on Mar. 9, 2026.

(51) Int. Cl. B01D 39/18; B01D 46/52

(52) U.S. Cl. CPC B01D 39/18; B01D 46/525; B01D 2239/0464; B01D 2239/10; B01D 2239/1233; B01D 2239/1291

(57) ABSTRACT

A filter media including a single layer having fibers and an impregnate capable of binding a basic contaminant, an acidic contaminant, or a volatile organic compound. The filter media is configured to filter a dust and a gaseous component, where the gaseous component includes the basic contaminant, the acidic contaminant, or the volatile organic compound. The filter media is capable of being configured into a filter element or filter.

### CROSS REFERENCE TO RELATED APPLICATIONS

This application claims the benefit of U.S. Provisional Patent Application No. 63/803,239, filed May 9, 2025, and of U.S. Provisional Patent Application No. 64/000,746, filed Mar. 9, 2026, which are incorporated herein by reference in their entireties.

### SUMMARY

In one or more embodiments, the present disclosure provides a filter media. The filter media includes a first layer having fibers and an impregnate. The impregnate may be capable of binding a basic contaminant or an acidic contaminant. Further, the impregnate may be present at 5 g/m² or greater by area of the filter media. Moreover, the filter media has a dust filtration efficiency of 15% or greater as measured by ASTM F1215-89.

In one or more embodiments, the present disclosure provides filter media that includes a laminated media. The laminated media includes two or more first layers, where each first layer includes fibers and an impregnate. The impregnate may be capable of binding a basic contaminant or an acidic contaminant. Further, the impregnate may be present at 5 g/m² or greater by area of the filter media. Moreover, the filter media has a dust filtration efficiency of 15% or greater as measured by ASTM F1215-89.

In one or more embodiments, the present disclosure provides a filter element including a media pack having an inlet end and an outlet end. The media pack further including a first layer having fibers and an impregnate capable of binding a basic contaminant or an acidic contaminant. The impregnate may be present at 5 g/m² or greater by area of the media pack. Further, the media pack may have a dust filtration efficiency of 15% or greater as measured by ASTM F1215-89. The filter element may include a laminated media. The laminated media may include two or more of the first layer. The laminated media may include two or more of the second layer. The second layer may be different from the first layer. The second layer may be a separation layer.

In one or more embodiments, the present disclosure provides a filter including a first filter element and having a first filter media and a second filter element having a second filter media. The first filter media includes a layer having fibers and a first impregnate. The first impregnate may be present at 5 g/m² or greater by area of the filter media. The first filter media may further have a dust filtration efficiency of 98% or greater as measured by ISO 5011:2020 using ISO fine (A2) dust, or 15% or greater as measured by ASTM F1215-89. The second filter media includes a layer having fibers and a second impregnate. The second impregnate may be present at 5 g/m² or greater by area of the filter media. The second filter media may further have a dust filtration efficiency of 98% or greater as measured by ISO 5011:2020 using ISO fine (A2) dust, or 15% or greater as measured by ASTM F1215-89. The first filter element and the second filter element may be independently capable of binding a basic contaminant, an acidic contaminant, or a VOC, where at least one of the first filter element and the second filter element is capable of binding a basic contaminant or an acidic contaminant.

In one or more embodiments, the present disclosure provides a method of filtering air, the method includes passing an airflow through a filter including a filter media. The filter media include a first layer having fibers and an impregnate capable of binding a basic contaminant or an acidic contaminant. The impregnate may be present at 5 g/m² or greater by area of the filter media. Further, the filter media may have a dust filtration efficiency of 98% or greater as measured by ISO 5011:2020 using ISO fine (A2) dust, or 15% or greater as measured by ASTM F1215-89.

### BRIEF DESCRIPTION OF DRAWINGS

FIG. 1 is a perspective view of one embodiment of a filter media.

FIG. 2 is a cross-sectional view A-A of the filter media of FIG. 1.

FIG. 3 is a perspective view of one embodiment of a filter element.

FIG. 4 is a cross-sectional view B-B of the filter element of FIG. 3.

FIG. 5 is a perspective view of fluted media including the filter media according to an embodiment.

FIGS. 6A and 6B are perspective views of a filter according to embodiments.

FIG. 7A is a cutaway perspective view of one embodiment of a laminated media.

FIG. 7B is a cross-sectional view C-C of the laminated media of FIG. 7A.

FIG. 7C is a schematic diagram of a lamination process for making the laminated media of FIGS. 7A-7B according to an embodiment.

FIG. 8A is a cutaway perspective view of one embodiment of a laminated media.

FIG. 8B is a cross-sectional view D-D of the laminated media of FIG. 8A.

FIG. 8C is a schematic diagram of a lamination process or making the laminated media of FIGS. 8A-8B according to an embodiment.

### DEFINITIONS

“Adsorbent” is used herein to refer to a material that is capable of adsorption. An adsorbent material has the ability to attract and hold molecules, atoms, or ions from a gas, liquid, or dissolved solid onto the surface of the adsorbent material. “Adsorption” generally means forming a surface bond with a chemical constituent. Adsorption is used herein to encompass physisorption, which is the physical bonding, and chemisorption, which is a chemical bond resulting from a chemical reaction.

“Media face” is used herein to refer to major surface of the media that faces the flow of fluid. In the context of filter media, the “flow face” refers to the media face.

“Element face” is used herein to refer to the region of a filter element through which fluid flows into the filter element. In the context of filter element, the “flow face” refers to the element face.

“Fiber diameter” is used herein to refer to an average diameter of a population of fibers. Fiber diameter may be measured using a top-down SEM image. The sample may be sputter-coated. A useful sputter-coater may be a gold and palladium mixture including, for example, an Au:Pd 60:40 mixture. A more accurate fiber diameter measurement may be obtained by measuring the diameter of the fiber in at least 30 locations in the sample. Software such as a SCANDIUM, SMILEVIEW-MAP10, or IMAGEPRO may be useful for analyzing fiber diameters.

“Filter element” is used herein to refer to a media pack that is configured for installation into a system to filter fluids. Typically, the filter element includes additional components such as a sealing member, support frame, handle, or other structures.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements. The term “consisting of” means “including,” and is limited to whatever follows the phrase “consisting of.” Thus, the phrase “consisting of” indicates that the listed elements are required or mandatory and that no other elements may be present. The term “consisting essentially of” means including any elements listed after the phrase, and is limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” are used herein for embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally used in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used.

The term “substantially” as used here has the same meaning as “nearly completely,” and can be understood to modify the term that follows by at least about 90%, at least about 95%, or at least about 98%.

The term “substantially free” as used here has the same meaning as “nearly completely free.” The term “substantially free” maybe interpreted in the context of the substance that is being discussed and can be understood to refer to an amount that is at least about 99% less than a typical amount of the substance. For example, in reference to a substance that may typically be present at a level of about 10 wt-%, substantially free may be understood to refer to less than 0.1 wt-% of the substance.

Herein, “up to” a number (e.g., up to 50) includes the number (e.g., 50). Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### DETAILED DESCRIPTION

The present disclosure relates to filter media, filter elements, and filters that are capable of chemical filtration and dust filtration in a single filter media. Such filter media, filter elements, and filters can be advantageous in applications, for example, automotive, electronics, chemical processing, aerospace, agriculture, or any other application that may benefit from chemical filtration and dust filtration simultaneously. Further, such filter media, filter elements, and filters can be advantageous in applications where space is limited because the filter media, filter elements, and filters can eliminate the need for separate dust and chemical filters.

Some embodiments of the current technology effectively and efficiently provide chemical filtration and dust filtration capabilities in the same filter media. Further, some embodiments of the current technology effectively and efficiently provide chemical filtration and dust filtration capabilities in one filter. Such a configuration may advantageously reduce or eliminate negative impacts of chemical contaminants and particulate (e.g., dust) on downstream filtration processes without the need for two separate filters. Traditional filter systems often utilize two separate filters to filter out chemical contaminants and dust. Such traditional filter systems, however, are inefficient and impractical in some applications (e.g., space constrained applications). Moreover, traditional filter systems that are effective at removing chemical contaminants are generally not well-suited for dust filtration. Likewise, traditional filter systems that are effective at dust filtration are generally not well-suited for removing chemical contaminants. Thus, there is a need for a filter media that is capable of efficient chemical contaminant filtration and dust filtration. Embodiments of the present disclosure provide such filter media, filter elements, and filters.

### Filter Media

In general, the filter media of the present disclosure may be configured to remove chemical contaminants while simultaneously providing efficient dust filtration. The filter media generally includes fibrous filter media (“fibrous media”) and an impregnate. The fibrous filter media includes fibers that may be selected to achieve a desired dust filtration efficiency or MERV rating. Further, the impregnate may be selected to achieve a desired filtration of a target chemical contaminant.

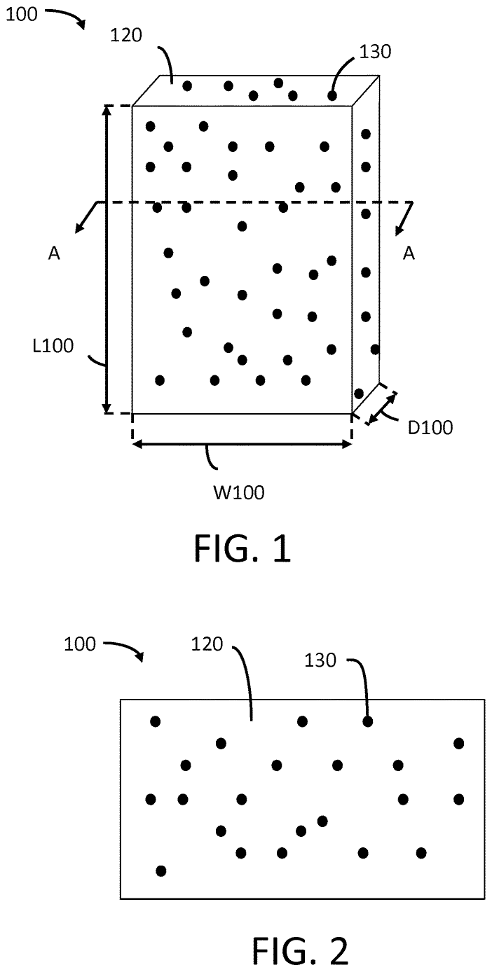

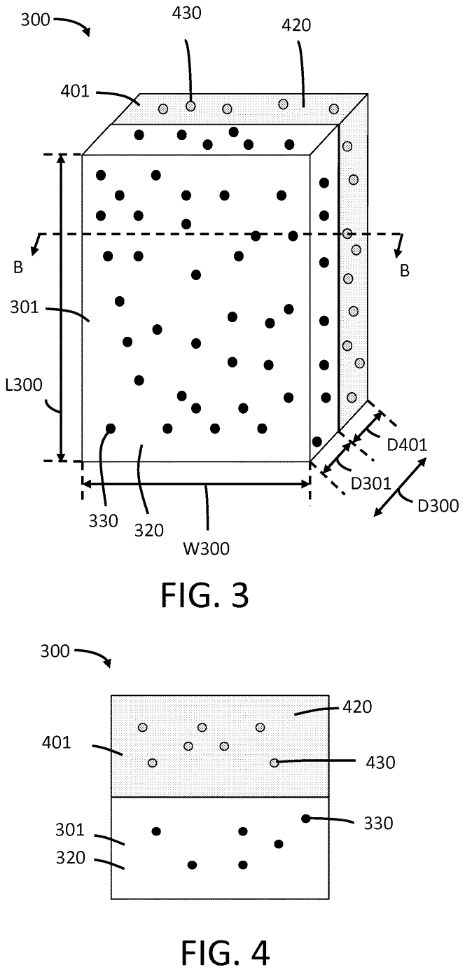

As shown in FIGS. 1 and 2, the filter media 100 includes fibrous media 120. In some embodiments, the fibers of the fibrous media 120 have a diameter of 0.1 μm or greater, 0.5 μm or greater, 1 μm or greater, 5 μm or greater, 10 μm or greater, 20 μm or greater, 30 μm or greater, 40 μm or greater, 50 μm or greater, 60 μm or greater, 70 μm or greater, 80 μm or greater, 90 μm or greater, 95 μm or greater, 100 μm or greater, 200 μm or greater, or 450 μm or greater. In some embodiments, the fibers of the fibrous media 120 have a diameter of 500 μm or less, 200 μm or less, 100 μm or less, 99 μm or less, 95 μm or less, 90 μm or less, 80 μm or less, 70 μm or less, 60 μm or less, 50 μm or less, 40 μm or less, 30 μm or less, 20 μm or less, 10 μm or less, 5 μm or less, or 1 μm or less. In some embodiments, the fibers of the fibrous media 120 have a diameter in a range of 1 μm to 500 μm, 5 μm to 250 μm, 10 μm to 90 μm, 20 μm to 80 μm, 30 μm to 70 μm, or 40 μm to 60 μm.

The filter media 100 further includes an impregnate 130, as discussed in more detail below. The impregnate 130 may be dispersed throughout or on the surface of the fibrous media 120. In some embodiments, the impregnate 130 is dispersed throughout the depth D100 of the filter media 100 (e.g., the fibrous media 120). In some embodiments, the impregnate 130 is disposed on the surface of the filter media 100 (e.g., the fibrous media 120).

The fibrous media may be formed by any suitable manufacturing process. The fibrous media may include woven or nonwoven media. The fibers of the fibrous media may be made using a variety of techniques including electrostatic spinning, force spinning, melt blowing, wet spinning, dry spinning, melt spinning, spunbond, extrusion spinning, direct spinning, gel spinning, islands-in-the-sea method, and the like. Natural fibers may be obtained from plant or animal sources and may be further treated or refined, e.g., regenerated or microfibrillated. Examples of suitable fiber materials include cellulose fibers, synthetic fibers, glass fibers, and combinations of two or more thereof. Examples of synthetic fibers used in the fiber material include polyester, polypropylene, polyamide, polysulfone, sulfonated polysulfone, polyimid, polyvinylidine fluoride, polyvinyl chloride, chlorinated polyvinyl chloride, polycarbonate, nylon, aromatic nylons, cellulose esters, poly(meth)acrylate, polystyrene, polyvinyl butyryl, polyvinyl alcohol, polyethylene oxide, or a copolymer of any two or more thereof. The fibrous media may be flexible or non-flexible material such that the desired filtration is achieved without compromising the structure of the filter media 100.

The filter media may be configured in any suitable shape or size. FIGS. 1 and 2 depict a perspective view and a cross-section view A-A (respectively) of one embodiment of a filter media of the present disclosure. The filter media 100 has a width W100, a length L100, and a depth D100.

The filter media 100 may have any suitable basis weight. The basis weight of a filter media is the mass of the filter media per unit area. The basis weight impacts various properties of the filter media, such as filtration capacity, efficiency, flow resistance, durability, etc. The filter media 100 may have suitable basis weight such that efficient chemical contaminant and dust filtration are achieved consistent with the embodiments of the present disclosure. In some embodiments, the basis weight of the filter media 100 is 5 g/m² or greater, 10 g/m² or greater, 20 g/m² or greater, 30 g/m² or greater, 40 g/m² or greater, 50 g/m² or greater, 100 g/m² or greater, 150 g/m² or greater, 200 g/m² or greater, 250 g/m² or greater, 300 g/m² or greater, 350 g/m² or greater, 400 g/m² or greater, 450 g/m² or greater, or 490 g/m² or greater. In some embodiments, the basis weight of the filter media 100 is 500 g/m² or less, 499 g/m² or less, 495 g/m² or less, 450 g/m² or less, 400 g/m² or less, 350 g/m² or less, 300 g/m² or less, 250 g/m² or less, 200 g/m² or less, 150 g/m² or less, 100 g/m² or less, 50 g/m² or less, or 10 g/m² or less. In some embodiments, the basis weight of the filter media 100 is in a range of 1 g/m² to 500 g/m², 100 g/m² to 400 g/m², or 250 g/m² to 350 g/m².

The filter media 100 may have any suitable density. The density of the filter media 100 is the mass of the filter media per unit volume. The density of the filter media 100 impacts various properties of the filter media such as, filtration capacity, efficiency, flow resistance, durability, etc. The filter media 100 may have any suitable density such that efficient chemical contaminant and dust filtration are achieved. In some embodiments, the density of the filter media 100 is 80 kg/m³ or greater, 90 kg/m³ or greater, 100 kg/m³ or greater, 150 kg/m³ or greater, 200 kg/m³ or greater, 250 kg/m³ or greater, 300 kg/m³ or greater, 350 kg/m³ or greater, 400 kg/m³ or greater, 450 kg/m³ or greater, 500 kg/m³ or greater, 525 kg/m³ or greater, 540 kg/m³ or greater, 545 kg/m³ or greater, or 550 kg/m³ or greater. In some embodiments, the density of the filter media 100 is 550 kg/m³ or less, 540 kg/m³ or less, 525 kg/m³ or less, 500 kg/m³ or less, 450 kg/m³ or less, 400 kg/m³ or less, 350 kg/m³ or less, 300 kg/m³ or less, 250 kg/m³ or less, 200 kg/m³ or less, 150 kg/m³ or less, 100 kg/m³ or less, or 90 kg/m³ or less. In some embodiments, the density of the filter media 100 is in a range of 80 kg/m³ to 550 kg/m³, 90 kg/m³ to 525 kg/m³, or 100 kg/m³ to 500 kg/m³.

The filter media 100 may have any suitable depth. The depth of the filter media 100 may be understood as the thickness of a sheet of filter media. In some embodiments, the filter media has a depth D100 of 0.1 mm or greater, 1 mm or greater, 10 mm or greater, 50 mm or greater, 100 mm or greater, 200 mm or greater, or 450 mm or greater. In some embodiments, the filter media has a depth D100 of 500 mm or less, 250 mm or less, 100 mm or less, 50 mm or less, 10 mm or less, or 1 mm or less. In some embodiments, the filter media 100 has a depth D100 in a range of 0.1 mm to 500 mm, 1 mm to 500 mm, 1 mm to 250 mm, 1 mm to 200 mm, 1 mm to 150 mm, 1 mm to 100 mm, 1 mm to 50 mm, 1 mm to 25 mm, or 1 mm to 10 mm.

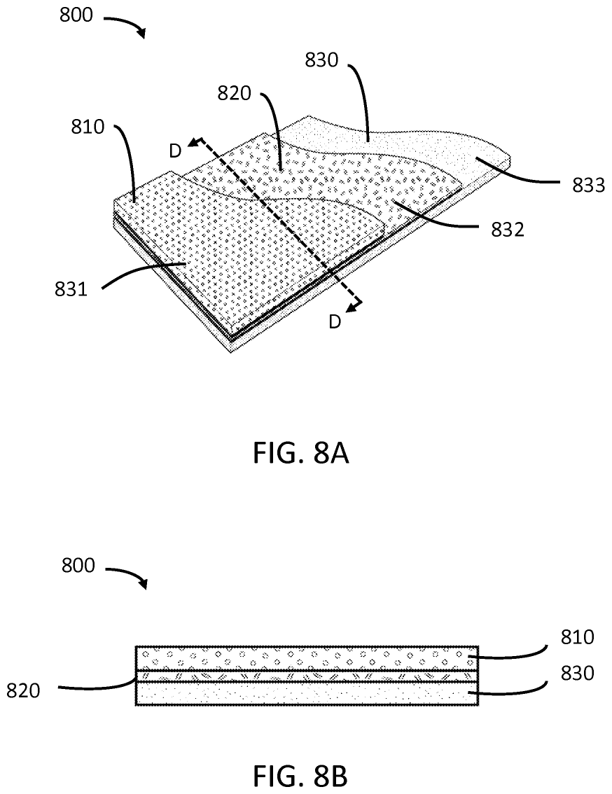

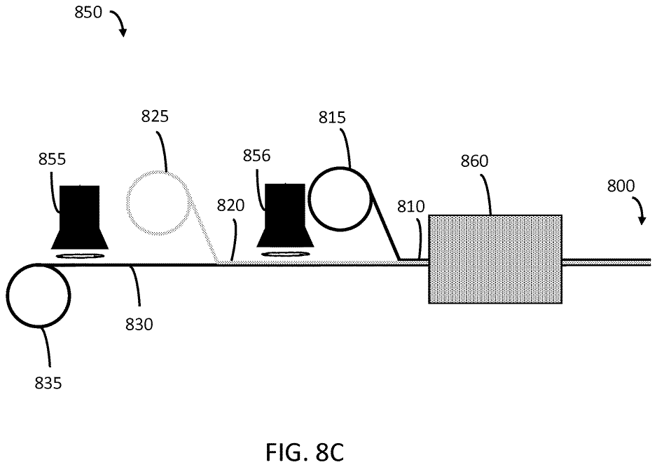

The filter media 100 may be a single layer of media, as shown in FIGS. 1 and 2. In some embodiments, the filter media may be a laminated media that includes two or more layers coupled via lamination. Laminated media is further discussed below with regard to FIGS. 7A-8C.

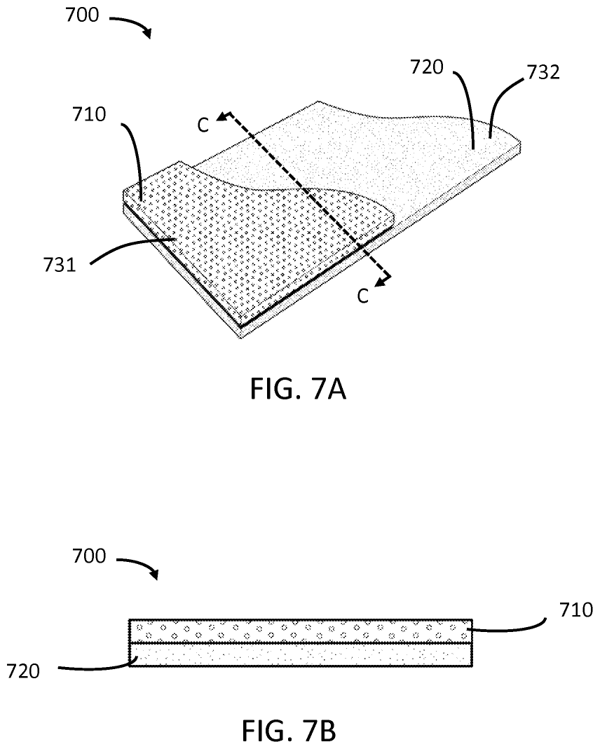

According to embodiments of the present disclosure, the filter media 100 may be configured as a sheet of filter media 100. The sheet of filter media 100 may be configured in any suitable shape. Examples of suitable shapes of the sheet of filter media 100 may include pleats, flat facing sheets, flutes, or the like. In some embodiments, the filter media 100 includes a fluted sheet, a facing sheet, and a plurality of flutes formed between the fluted sheet and the facing sheet, where the fluted sheet includes repeating internal peaks facing toward the facing sheet and repeated external peaks facing away from the facing sheet. An example of fluted sheets as part of a filter element 500 is shown in FIG. 5, discussed in further detail below.

According to embodiments of the present disclosure, the filter media 100 may be configured in a dust filtration layer that exhibits filtration characteristics of dust media substrates without the enhancement of a secondary process to apply fine fiber.

### Chemical Filtration

According to embodiments, the filter media 100 is capable of chemical filtration. This capability may be primarily due to the presence of an impregnate 130 in the filter media 100, as shown in FIGS. 1 and 2. The impregnate 130 may be dispersed in or on the fibrous media 120 in any suitable configuration. For example, the impregnate 130 may be dispersed substantially or completely throughout the fibrous media 120. In some embodiments, the impregnate 130 is dispersed throughout the depth D100 of the filter media 100 (e.g., the fibrous media 120). Alternatively, the impregnate 130 may be dispersed selectively throughout the fibrous media 120. In some embodiments, the impregnate 130 is disposed on the surface of the filter media 100 (e.g., the fibrous media 120).

The filter media 100 includes a suitable amount of an impregnate 130. Any suitable amount of an impregnate may be used according to the target contaminant, the expected concentration of the target contaminant, and/or desired filtration efficiency. The amount of the impregnate may be expressed relative to the surface area of the flat filter media 100 (e.g., prior to fluting or any other manipulation of its shape). In some embodiments, the amount of impregnate 130 present in the filter media 100 is 5 g/m² or greater, 10 g/m² or greater, 20 g/m² or greater, 25 g/m² or greater, 30 g/m² or greater, 50 g/m² or greater, 75 g/m² or greater, 100 g/m² or greater, 125 g/m² or greater, 150 g/m² or greater, 155 g/m² or greater, or 160 g/m² or greater. In some embodiments, the amount of impregnate present in the filter media is 170 g/m² or less, 160 g/m² or less, 155 g/m² or less, 150 g/m² or less, 125 g/m² or less, 100 g/m² or less, 75 g/m² or less, 50 g/m² or less, 25 g/m² or less, 20 g/m² or greater, or 10 g/m² or less. In some embodiments, the amount of impregnate present in the filter media is in a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

The amount of the impregnate 130 may also be expressed as a density of the impregnate 130, as mass of the impregnate relative to the volume of filter media. Any suitable density of the impregnate 130 may be present according to the desired filter media 100 properties. In some embodiments, the filter media 100 includes an impregnate 130 present at a density of 60 g/m³ or greater, 75 g/m³ or greater, 100 g/m³ or greater, 200 g/m³ or greater, 300 g/m³ or greater, or 350 g/m³ or greater of the total volume of the filter media 100. In some embodiments, the filter media 100 includes an impregnate 130 present at a density of 500 g/m³ or less, 450 g/m³ or less, 400 g/m³ or less, 350 g/m³ or less, 300 g/m³ or less, 250 g/m³ or less, 200 g/m³ or less, 150 g/m³ or less, 125 g/m³ or less, 100 g/m³ or less, or 75 g/m³ or less of the total volume of the filter media 10. In some embodiments, the filter media 100 includes an impregnate 130 present in a range of 50 g/m³ to 500 g/m³, 100 g/m³ to 400 g/m³, or 200 g/m³ to 400 g/m³ of the total volume of the filter media 10.

The impregnate may be applied to the fibrous media 120 by any suitable process capable of bringing the impregnate in contact with the fibrous media 120. In some embodiments, the impregnate is applied to the fibrous media 120 by contacting or coating the fibers of the fibrous media 120 with a solution or suspension containing the impregnate. The impregnate may be included in the solution or suspension at a concentration of 1 wt-% to 50 wt-%, or from 15 wt-% to 40 wt-%. The solution or suspension may further optionally include a preservative. The preservative may be included in the solution or suspension at a concentration of 0.01 wt-% to 20 wt-%. Examples of suitable processes include dip coating, spraying, roll-to-roll coating, electrostatic coating, or any other suitable coating or application technique. In one embodiment, the fibers 120 of the filter media 100 are coated with an impregnate 130 using dip coating.

The filter media 100 may include one or more different impregnates or different types of impregnates. The impregnate may be selected based on various factors, including its capability to bind a target contaminant, availability of active sites, solubility in desired solvent, or environmental health and safety considerations. The filter media 100 may include one or more different impregnates selected from one or more different types. In some embodiments, the filter media is a laminated media, where different layers of the laminated media include different types of impregnates. Various types of impregnates are discussed in more detail below. According to some embodiments of the present disclosure, the filter media 100 is free of or substantially free of activated carbon.

The filter media 100 may be configured to have relatively high selectivity, adsorption capacity, and/or retention for a particular chemical contaminant (e.g., a target contaminant). Such chemical contaminants may include, for example, acidic contaminants, basic contaminants, and organic contaminants. In some embodiments, the chemical contaminants are in gaseous form or aerosols. Some exemplary contaminants include nitrogen oxide, sulfur dioxide, hydrogen sulfide, siloxanes, ammonia, n-butane, and aromatic hydrocarbons (e.g., benzene, toluene, or xylene).

The capacity of the filter media 100 to bind a target contaminant may be expressed in terms of a chemical breakthrough. In general, chemical breakthrough refers to the point at which a filter no longer effectively removes a target contaminant, thereby allowing the contaminant to pass through into the filtered output. This is typically expressed as a percentage of the inlet concentration of a contaminant that appears in the outlet stream. For example, a 1% breakthrough indicates a threshold of 1% of the contaminant present in the outlet when compared to the inlet. In other words, 1% of the contaminant present in the inlet is passing through the filter into the outlet. On the other hand, a 95% breakthrough occurs when 95% of the contaminant present in the inlet is passing through the filter into the outlet. The time to reach a specific breakthrough may depend on a plurality of factors such as, e.g., inlet flow rate, inlet face velocity, and the type of contaminant and its concentration. When the inlet flow rate is high, typically the time to breakthrough is lower when compared to when the inlet flow rate is low. Additionally, when concentration of a contaminant is high, the time to breakthrough is lower because the contaminant overwhelms the adsorption sites of the filter media 100 faster.

Breakthrough can be measured by ISO-11155-2:2009. Unless otherwise defined, breakthrough as used herein refers to testing according to ISO-11155-2:2009 using the following parameters: (i) a contaminant flow rate of 9.1 m³/min; (ii) a contaminant concentration of 30 parts per million; (iii) relative humidity of 50%; (iv) an air temperature of 23 °C; and (v) a face velocity of the contaminant of 3 m/s.

### Impregnate Capable of Binding an Acidic Contaminant

The filter media 100 may include an impregnate 130 capable of binding an acidic contaminant. In some embodiments, the filter media is a laminated media including one or more layers that include an impregnate 130 capable of binding an acidic contaminant. The impregnate 130 capable of binding an acidic contaminant may include any suitable acid-binding impregnate. Examples of suitable impregnates capable of binding an acidic contaminant include sodium carbonate, sodium bicarbonate, potassium carbonate, potassium bicarbonate, calcium carbonate, calcium bicarbonate; sodium hydroxide, potassium hydroxide, calcium hydroxide, lithium hydroxide; sodium metabisulfite, potassium metabisulfite; metal oxides; sodium silicate, potassium silicate; quaternary ammonium salts and polymers containing quaternary ammonium salts; silica gel (silicon dioxide/modified silicon dioxide); zeolites, molecular sieves, aluminosilicates; ion-exchange resins, and combinations of two or more thereof.

In some embodiments, the filter media 100 exhibits a maximum 1% breakthrough of an acidic contaminant for 10 min or greater, 15 min or greater, 20 min or greater, 22 min or greater, or 25 min or greater. While there is no desirable upper limit to the breakthrough time, in practice, a maximum 1% breakthrough of an acidic contaminant may occur at 60 min or less, 30 min or less, 25 min or less, or 23 min or less. In some embodiments, the filter media 100 exhibits a maximum 1% breakthrough of an acidic contaminant in a range of 15 min to 30 min, 20 min to 28 min, or 20 min to 25 min.

In some embodiments, the filter media 100 exhibits a maximum 10% breakthrough of an acidic component for 7 mins or greater.

In some embodiments, the filter media 100 exhibits a 50% breakthrough of an acidic component for 14 mins or greater.

In some embodiments, the filter media 100 exhibits below 95% breakthrough of an acidic contaminant for 550 min or greater, 575 min or greater, 600 min or greater, 625 min or greater, 636 min or greater, 650 min or greater, or 675 min or greater. In some embodiments, the filter media 100 exhibits below 95% breakthrough of an acidic contaminant for 700 min or less, 675 min or less, 650 min or less, 637 min or less, 625 min or less, 600 min or less, or 575 min or less. In some embodiments, the filter media 100 exhibits below 95% breakthrough of an acidic contaminant in a range of 550 min to 700 min, 600 min to 650 min, or 620 min to 640 min.

In some embodiments, the filter media includes an impregnate capable of binding an acidic component. Any suitable amount of an impregnate capable of binding an acidic component may be present in the filter media. In some embodiments, the filter media includes an impregnate capable of binding an acidic component is present at an amount of 5 g/m² or greater, 10 g/m² or greater, 20 g/m² or greater, 25 g/m² or greater, 30 g/m² or greater, 50 g/m² or greater, 75 g/m² or greater, 100 g/m² or greater, 125 g/m² or greater, 150 g/m² or greater, 155 g/m² or greater, or 160 g/m² or greater. In some embodiments, the amount of impregnate capable of binding an acidic component is 170 g/m² or less, 160 g/m² or less, 155 g/m² or less, 150 g/m² or less, 125 g/m² or less, 100 g/m² or less, 75 g/m² or less, 50 g/m² or less, 30 g/m² or less, 25 g/m² or less, 20 g/m² or greater, or 10 g/m² or less. In some embodiments, the amount of impregnate capable of binding an acidic component is in a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

In some embodiments, the filter media includes an impregnate comprising potassium iodide, potassium carbonate, tributyl ammonium hydroxide, sodium hydroxide, piperidine, piperazine, heterocyclic amine, or a combination of two or more thereof, where the impregnate is present at a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

### Impregnate Capable of Binding a Basic Contaminant

The filter media 100 may include an impregnate 130 capable of binding a basic contaminant. In some embodiments, the filter media is a laminated media including one or more layers that include an impregnate 130 capable of binding a basic contaminant. The impregnate 130 capable of binding a basic contaminant may include any suitable basic-binding impregnate.

Examples of suitable impregnates capable of binding a basic contaminant include carboxylic acid, sulfonic acid, sulfuric acid, phosphoric acid, nitric acid, hydrochloric acid, heteropoly acid, and combinations of two or more thereof. In some embodiments, examples of suitable impregnates capable of binding a basic contaminant include saturated, unsaturated, or aromatic-containing dicarboxylic acids (e.g., oxalic, malonic, succinic, glutaric, adipic, maleic, or fumaric acid, etc.); saturated, unsaturated, or aromatic-containing tricarboxylic acids (citric, aconitic, propane-1,2,3-tricarboxylic, or trimesic acid, etc.); saturated, unsaturated, or aromatic-containing multi-acids; boric acid; poly(meth)acrylic acid or other polymers containing carboxylic acid functionalities; sulfuric acid, phosphoric acid, nitric acid, hydrochloric acid; benzenesulfonic acid or other small molecule sulfonic acids, poly(styrenesulfonic acid) or other polymers containing sulfonic acid functionalities; silica gel (silicon dioxide/modified silicon dioxide); zeolites, molecular sieves, aluminosilicates; ion-exchange resins, and combinations of two or more thereof. In some embodiments, examples of suitable impregnates capable of binding a basic contaminant include a linear sulfonic acid, a cyclic sulfonic acid, an aromatic sulfonic acid, or a combination of two or more thereof.

In some embodiments, the filter media exhibits a maximum 1% breakthrough of a basic contaminant for 3 min or greater, 5 min or greater, 10 min or greater, 15 min or greater, 20 min or greater, 25 min or greater, 30 min or greater, 35 min or greater, or 45 min or greater. While there is no desirable upper limit to the breakthrough time, in practice, a maximum 1% breakthrough of a basic contaminant may occur at 60 min or less, 55 min or less, 50 min or less, 45 min or less, 40 min or less, 30 min or less, 25 min or less, 20 min or less, 15 min or less, 10 min or less, 5 min or less, or 3 min or less. In some embodiments, the filter media exhibits a maximum 1% breakthrough of a basic contaminant in a range of 3 min to 60 min, 3 min to 45 min, or 5 min to 45 min.

In some embodiments, the filter media 100 exhibits a maximum 10% breakthrough of a basic component for 27 mins or greater.

In some embodiments, the filter media 100 exhibits a 50% breakthrough of a basic component for 60 mins or greater.

In some embodiments, the filter media exhibits below 95% breakthrough of a basic contaminant for 600 min or greater, 650 min or greater, 680 min or greater, 700 min or greater, 750 min or greater, 800 min or greater, 850 min or greater, 900 min or greater, 950 min or greater, 972 min or greater, or 975 min or greater. In some embodiments, the filter media exhibits below 95% breakthrough of a basic contaminant for 975 min or less, 972 min or less, 950 min or less, 900 min or less, 850 min or less, 800 min or less, 750 min or less, 700 min or less, 680 min or less, 650 min or less, or 600 min or less. In some embodiments, the filter media exhibits below 95% breakthrough of a basic contaminant in a range of 600 min to 975 min, 650 min to 975 min, or 680 min to 972 min.

In some embodiments, the filter media includes an impregnate capable of binding a basic component. Any suitable amount of an impregnate capable of binding a basic component may be present in the filter media. In some embodiments, the filter media includes an impregnate capable of binding an basic component is present at an amount of 5 g/m² or greater, 10 g/m² or greater, 20 g/m² or greater, 25 g/m² or greater, 30 g/m² or greater, 50 g/m² or greater, 75 g/m² or greater, 100 g/m² or greater, 125 g/m² or greater, 150 g/m² or greater, 155 g/m² or greater, or 160 g/m² or greater. In some embodiments, the amount of impregnate capable of binding an basic component is 170 g/m² or less, 160 g/m² or less, 155 g/m² or less, 150 g/m² or less, 125 g/m² or less, 100 g/m² or less, 75 g/m² or less, 50 g/m² or less, 30 g/m² or less, 25 g/m² or less, 20 g/m² or greater, or 10 g/m² or less. In some embodiments, the amount of impregnate capable of binding a basic component is in a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

In some embodiments, the filter media includes an impregnate comprising carboxylic acid, sulfonic acid, sulfuric acid, phosphoric acid, nitric acid, hydrochloric acid, heteropoly acid, or a combination of two or more thereof, where the impregnate is present at a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

### Impregnate Capable of Binding an Organic Contaminant

The filter media 100 may include an impregnate 130 capable of binding an organic contaminant, such as a VOC (“volatile organic compound”) contaminant, a halogenated compound, or a halogen contaminant. In some embodiments, the filter media is a laminated media including one or more layers that include an impregnate 130 capable of binding an organic contaminant, such as a VOC contaminant, a halogenated compound, or a halogen contaminant. The impregnate 130 capable of binding a VOC contaminant may include any suitable VOC-binding impregnate. Examples of suitable impregnates capable of binding a VOC contaminant or another organic molecule include activated carbon, zeolite, metal-organic frameworks (MOFs), or other porous materials.

In some embodiments, the filter media exhibits a maximum 1% breakthrough of a VOC contaminant for 1 min or greater, 5 min or greater, 10 min or greater, 15 min or greater, 20 min or greater, 25 min or greater, 30 min or greater, 40 min or greater, 50 min or greater, 60 min or greater, 70 min or greater, 80 min or greater, 90 min or greater, or 100 min or greater. While there is no desirable upper limit to the breakthrough time, in practice, a maximum 1% breakthrough of a VOC contaminant may occur at 100 min or less, 90 min or less, 80 min or less, 70 min or less, 60 min or less, 50 min or less, 45 min or less, 40 min or less, 30 min or less, 25 min or less, 20 min or less, 15 min or less, 10 min or less, 5 min or less, or 1 min or less. In some embodiments, the filter media exhibits a maximum 1% breakthrough of a VOC contaminant in a range of 3 min to 60 min, 3 min to 45 min, or 5 min to 45 min.

In some embodiments, the filter media exhibits below 95% breakthrough of a VOC contaminant for 500 min or greater, 600 min or greater, 650 min or greater, 700 min or greater, 750 min or greater, 800 min or greater, 850 min or greater, 900 min or greater, 950 min or greater, or 1000 min or greater. In some embodiments, the filter media exhibits below 95% breakthrough of a VOC contaminant for 1000 min or less, 950 min or less, 900 min or less, 850 min or less, 800 min or less, 750 min or less, 700 min or less, 680 min or less, 650 min or less, 600 min or less, or 500 min or less. In some embodiments, the filter media exhibits below 95% breakthrough of a VOC contaminant in a range of 500 min to 1000 min, 650 min to 900 min, or 700 min to 850 min.

In some embodiments, the filter media includes an impregnate capable of binding a VOC component. Any suitable amount of an impregnate capable of binding a VOC component may be present in the filter media. In some embodiments, the filter media includes an impregnate capable of binding a VOC component present at an amount of 5 g/m² or greater, 10 g/m² or greater, 20 g/m² or greater, 25 g/m² or greater, 30 g/m² or greater, 50 g/m² or greater, 75 g/m² or greater, 100 g/m² or greater, 125 g/m² or greater, 150 g/m² or greater, 155 g/m² or greater, or 160 g/m² or greater. In some embodiments, the amount of impregnate capable of binding a VOC component is 170 g/m² or less, 160 g/m² or less, 155 g/m² or less, 150 g/m² or less, 125 g/m² or less, 100 g/m² or less, 75 g/m² or less, 50 g/m² or less, 30 g/m² or less, 25 g/m² or less, 20 g/m² or greater, or 10 g/m² or less. In some embodiments, the amount of impregnate capable of binding a VOC component is in a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

In some embodiments, the filter media includes an impregnate comprising activated carbon, zeolite, metal-organic frameworks (MOFs), or a combination of two or more thereof, where the impregnate is present at a range of 1 g/m² to 160 g/m², 5 g/m² to 160 g/m², 10 g/m² to 160 g/m², 25 g/m² to 150 g/m², 30 g/m² to 125 g/m², 30 g/m² to 100 g/m², 30 g/m² to 75 g/m², or 40 g/m² to 50 g/m².

The filter media may further optionally include a preservative. Examples of suitable preservatives include sodium benzoate, potassium nitrate, sodium propionate, potassium nitrile, sodium sulfite, sodium sulfate, potassium sorbate, sorbic acid, benzoic acid, and combinations of two or more thereof. In some embodiments, the preservative is sodium benzoate.

### Dust Filtration

According to embodiments the present disclosure, the filter media 100 has advantageous dust filtration properties when compared to traditional chemical filters. For example, the filter media 100 of the present disclosure may have a dust filtration efficiency comparable to standard dust filters. Dust filtration efficiency generally determines the retention capabilities of the filter media 100 when exposed to coarse dust or a fine dust at a constant or variable air flow. Dust filtration efficiency can be measured by comparing the amount of particles that pass through the filter to the amount of particles in the inlet flow. Different methods, such as ASTM F1215-89 or ISO 5011:2020 can be used to measure dust filtration efficiency. Measurements using ISO 5011 may be performed with ISO fine (A2) dust as defined by ISO 12103-1:2024. Measurements using ASTM F1215-89 5011 may be performed with 0.8 μm particles.

In some embodiments, the filter media 100, when tested according to ASTM F1215-89 using 0.8 μm particles, has a dust filtration efficiency of 15% or greater, 20% or greater, 30% or greater, 40% or greater, or 50% or greater.

In some embodiments, the filter media 100, when tested according to ISO 5011:2020, using ISO fine dust, has an efficiency of 95% or greater, 96% or greater, 97% or greater, 98% or greater, 99% or greater, 99.5% or greater, 99.8% or greater, 99.9% or greater, or 99.95% or greater.

In some embodiments, the filter media 100 has a dust filtration efficiency of 20% or greater for particles having an average particle size of 0.3 μm. While there is no desired upper limit for dust filtration efficiency, in practice, filtration efficiency is typically below 100%.

The dust filtration properties of the filter media 100 may be described using a minimum efficiency reporting value (MERV) rating. The MERV ratings are standardized by the American Society of Heating, Refrigeration and Air Conditioning Engineers (ASHRAE). The MERV rating measures how effectively an air filter captures particles in the air. MERV ratings range from 1 (efficiency of less than 20% for average particle size 3.0-10.0 μm) to 16 (efficiency greater than or equal to 95% for average particle size 0.30-1.0 μm; efficiency greater than or equal to 95% for average particle size 1.0-3.0 μm; and efficiency greater than or equal to 95% for average particle size 3.0-10.0 μm), and the highest rating “HEPA” (high efficiency particulate air filter, greater than 99.97% efficiency for 0.3 μm particles). Unless otherwise defined, MERV rating as used herein refers to ASHRAE 52.2-2017 that outlines the testing protocol.

In some embodiments, the filter media 100 has a MERV rating of 10 or greater, 11 or greater, 12 or greater, or 13 or greater. In some embodiments, the filter media 100 has a MERV rating in a range of 10 to 14, 11 to 13, or 10 to 13.

The efficiency of the filter media 100 may also be expressed in terms of its dust loading capacity. Dust loading capacity is the measure of the amount of dust or particulate that a filter media can hold before degrading in performance. Dust loading capacity may be determined using a coarse dust or a fine dust at a constant or variable air flow.

In some embodiments, the filter media 100 has a dust loading capacity of 350 g or greater measured at a face velocity of 3 m/s and a depth of 100 mm. In some embodiments, the filter media 100 has a dust loading capacity of 475 g or greater, or 800 g or greater measured at a face velocity of 3 m/s and a depth of 100 mm. In some embodiments, the filter media 100 has a dust loading capacity of 700 g or greater, 1700 g or greater, or 1900 g or greater measured at a face velocity of 3 m/s and a depth of 150 mm. In some embodiments, the filter media 100 has a dust loading capacity of 1100 g or greater, 2600 g or greater, or 2900 g or greater measured at a face velocity of 3 m/s and a depth of 200 mm.

While there is no desirable upper limit for the dust loading capacity of the filter media, in practice, the dust loading capacity at a depth of 100 mm may be 1000 g or less; the dust loading capacity at a depth of 150 mm may be 2000 g or less; and the dust loading capacity at a depth of 200 mm may be 3000 g or less.

### Filter Element

The filter media 100 may be formed into a filter element. For example, the filter media may be shaped, e.g., by fluting, pleating, layering lamination, or other suitable methods. The filter media may be layered with other materials, such as other filter media or one or more face layers or support layers. Further, multiple layers of filter media may be stacked to form a media pack.

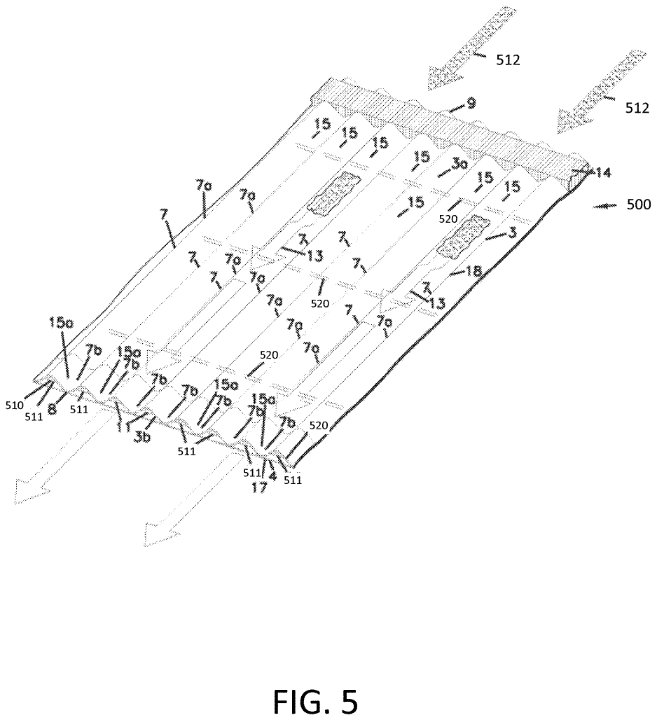

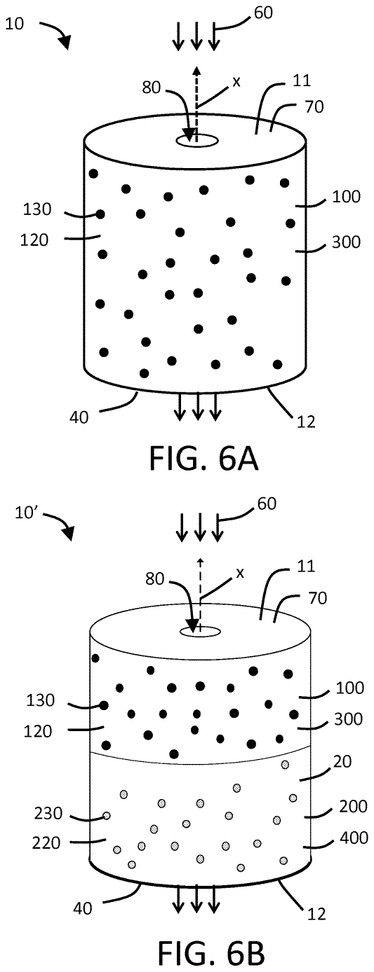

FIGS. 3 and 4 depict a perspective view and a cross-section view B-B (respectively) of one embodiment of a filter element 10. The filter element 10 includes a media pack 300 having an inlet end 11 and an outlet end 12. A media pack typically refers to multiple sheets of the media in a layered configuration. The inlet end 11 and the outlet end 12 may be located in any suitable location depending on the configuration of the filter element, intended direction of fluid flow, etc.

The filter element 10 contains the filter media 100 discussed elsewhere herein. The properties of the filter media 100 included in the filter element 10 are discussed above in the filter media, chemical filtration, and dust filtration sections. The filter element 10 contains the filter media 100 that is configured to provide chemical filtration and dust filtration capabilities. The filter media 100 may be configured as one or more media packs.

The filter element 10 may include a first media pack 300 and a second media pack 400. The first media pack 300 includes first fibrous media 320 and a first impregnate 330. The second media pack 400 includes second fibrous media 420 and a second impregnate 430. In some embodiments, the filter element 10 includes a plurality of media packs. The filter element 10 may include 2 or more, 3 or more, 4 or more, or 5 or more media packs. The filter element 10 may include up to 10 media packs, up to 8 media packs, up to 6 media packs, or up to 4 media packs. The media packs included in the filter media 10 may be the same kind or may be different from one another. The filter element 10 includes two or more media packs 300, 400, where each of the media packs is configured for filtering a dust and a chemical contaminant. The chemical contaminant may be a gaseous contaminant or aerosol contaminant. The chemical contaminant may include a basic contaminant, an acidic contaminant, a volatile organic contaminant, or a combination thereof. The different media packs may be configured to target different chemical contaminants.

The media packs 300, 400 include the filter media 100 as described elsewhere herein. The properties of the filter media 100 included in the media packs 300, 400 may have similar or same properties as described herein with respect to the chemical filtration and dust filtration (e.g., dust filtration efficiency, dust loading capacity, chemical breakthrough, etc.).

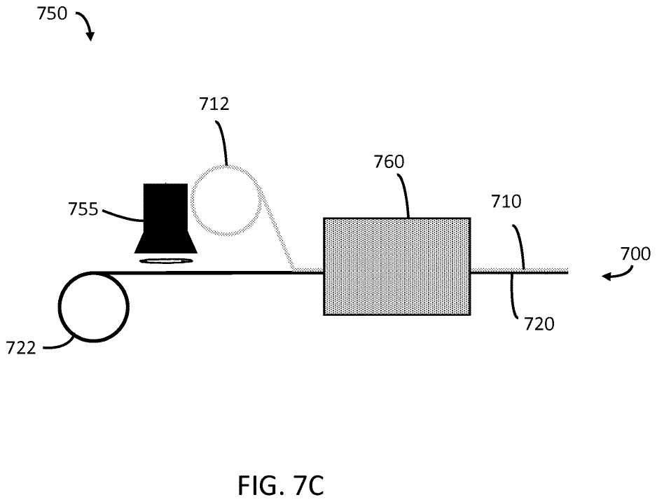

The filter element 10 has a width W10, a length L10, and a depth D10, where the width W10 and the length L10 are perpendicular to the depth D10. Any of the dimensions listed herein may be changed as desired, for example according to the orientation of the media pack 300, 400 within the filter element 10. In some embodiments, the filter element 10 has any suitable shape that includes any suitable length L10, depth D10, or width W10. In some embodiments, the filter element 10 is a cylindrical shape (e.g., as shown in FIGS. 6A and 6B) with a height and a diameter. The filter element 10 has a length L10 that is the length of either the first media pack L300 or the second media pack L400, whichever is larger. In some embodiments, the filter element 10 has a length L10 in a range of 50 mm to 800 mm, 300 mm to 700 mm, 400 mm to 600 mm, or 400 mm to 500 mm. The filter element 10 also has a depth D10 that is a sum total of the depth of the media packs that make up the filter element 10, e.g., the first media pack D300 and the second media pack D400. In some embodiments, the filter element 10 has a depth D10 in a range of 2 mm to 1000 mm, 2 mm to 500 mm, 2 mm to 400 mm, 2 mm to 300 mm, 2 mm to 200 mm, 2 mm to 100 mm, 2 mm to 50 mm, or 2 mm to 20 mm. Furthermore, the filter element 10 has a width W10 that is the width of either the first media pack L300 or the second media pack W400, whichever is larger. In some embodiments, the filter element 10 has a width W10 in a range of 10 mm to 400 mm, 50 mm to 350 mm, 300 mm to 300 mm, or 150 mm to 250 mm.

In some embodiments, the first fibrous media 320 of the media pack 300 may be the same as the second fibrous media 420 of the second media pack 400, or they may be different. In some embodiments, the first media pack 300 and the second media pack 400 may include fibers that include any suitable fiber source listed above herein with respect to the fibrous media.

The filter element 10 may be characterized in terms of its dust filtration efficiency, or the dust filtration efficiency of the media packs that make up the filter element. In some embodiments, the media pack 300, 400 of the filter element 10 has a dust filtration efficiency of 98% or greater as measured by ISO 5011:2020 using ISO fine (A2) dust, or 15% or greater as measured by ASTM F1215-89 using 0.8 μm particles. In some embodiments, the media pack 300, 400 of the filter element 10 has a dust filtration efficiency of 99.5% as measured by ISO 5011:2020 using ISO fine (A2) dust, or 20% or greater as measured by ASTM F1215-89 using 0.8 μm particles. In some embodiments, the media pack 300, 400 of the filter element 10 has a dust filtration efficiency of 99.95% as measured by ISO 5011:2020 using ISO fine (A2) dust, or 30% or greater as measured by ASTM F1215-89 using 0.8 μm particles.

In some embodiments, the media pack 300, 400 of the filter element 10 has a dust filtration efficiency of 70% or greater for particles having an average particle size of 0.3 μm.

The media pack 300, 400 is configured for filtering dust and a chemical contaminant. The chemical contaminant may be a gaseous contaminant or aerosol contaminant. The chemical contaminant may include a basic contaminant, an acidic contaminant, a volatile organic contaminant, or a combination thereof. In some embodiments, each of the first media pack 300 and the second media pack 400 are configured for filtering dust and a chemical contaminant, where the chemical contaminant includes a basic contaminant or an acidic contaminant. In some embodiments, the first media pack 300 and the second media pack 400 are configured for filtering dust and two or more different chemical contaminants, where the chemical contaminants are selected from a basic contaminant, an acidic contaminant, and an organic contaminant (e.g., a VOC). In some embodiments, the first media pack 300 is configured for filtering dust and a basic contaminant, and the second media pack 400 is configured for filtering dust and an acidic contaminant. In some embodiments, the first media pack 300 is configured for filtering dust and a basic or acidic contaminant, and the second media pack 400 is configured for filtering dust and an organic contaminant (e.g., a VOC).

In some embodiments, the impregnate 330 of the media pack 300 may be the same as the impregnate 430 of the second media pack 400, or they may be different. The filter element 10 may include a plurality of media packs, each with an impregnate that is independently selected from the impregnates discussed herein. Each media pack may further include a plurality of impregnates (e.g., acidic, basic, or VOC contaminant capturing impregnates).

FIG. 5 of a schematic of fluted media 500 including the filter media 100 as described elsewhere herein. The fluted media 500 is formed from a fluted, in this instance corrugated, sheet 3 and a facing sheet 4. The fluted sheet 3 may be made of the filter media 100 of the present disclosure. A construction such as fluted media 500 is referred to herein as a single facer or single faced strip. In some embodiments, fluted media 500 is formed from a fluted laminated media and a facing sheet 4.

Sometimes, the corrugated fluted or ridged sheet 3, shown in FIG. 5, is of a type generally characterized herein as having a regular, curved, wave pattern of flutes, ridges or corrugations 7. The term “wave pattern” in this context, is meant to refer to a flute, ridge or corrugated pattern of alternating troughs 7b and ridges 7a. The term “regular” in this context is meant to refer to the fact that the pairs of troughs and ridges (7b, 7a) alternate with generally the same repeating corrugation (flute or ridge) shape and size. (Also, typically in a regular configuration each trough 7b is substantially an inverse ridge for each ridge 7a.) The term “regular” is thus meant to indicate that the corrugation (or flute) pattern comprises troughs (inverted ridges) and ridges with each pair (comprising an adjacent trough and ridge) repeating, without substantial modification in size and shape of the corrugations along at least 70% of the length of the flutes. The term “substantial” in the context of FIG. 5, refers to a modification resulting from a change in the process or form used to create the corrugated or fluted sheet, as opposed to minor variations from the fact that the media sheet 3 is flexible. With respect to the characterization of a repeating pattern, it is not meant that in any given filter construction, an equal number of ridges and troughs is necessarily present. The fluted media 500 could be terminated, for example, between a pair comprising a ridge and a trough, or partially along a pair comprising a ridge and a trough. (For example, in FIG. 5 the fluted media 500 depicted in fragmentary has eight complete ridges 7a and seven complete troughs 7b.) Also, the opposite flute ends (ends of the troughs and ridges) may vary from one another. Such variations in ends are disregarded in these definitions, unless specifically stated. That is, variations in the ends of flutes are intended to be covered by the above definitions.

In the context of the characterization of a “curved” wave pattern of corrugations, in certain instances the corrugation pattern is not the result of a folded or creased shape provided to the media, but rather the apex 7a of each ridge and the bottom 7b of each trough is formed along a radiused curve. A typical radius for such z-filter media would be at least 0.25 mm and typically would be no more than 3 mm.

An additional characteristic of the particular regular, curved, wave pattern depicted in FIG. 5, for the corrugated sheet 3, is that at approximately a region 530 between each trough and each adjacent ridge, along most of the length of the flutes 7, is located a transition region where the curvature inverts. For example, viewing back side or face 3a, FIG. 5, trough 7b is a concave region, and ridge 7a is a convex region. When viewed toward front side or face 3b, trough 7b of side 3a forms a ridge; and ridge 7a of face 3a, forms a trough. (In some instances, region 530 can be a straight segment, instead of a point, with curvature inverting at ends of the segment 530.)

A characteristic of the particular regular wave pattern fluted (in this instance corrugated) sheet 3 shown in FIG. 5, is that the individual corrugations, ridges or flutes are generally straight, although alternatives are possible. By “straight” in this context, it is meant that through at least 70%, typically at least 80% of the length, the ridges 7a and troughs (or inverted ridges) 7b do not change substantially in cross-section. The term “straight” in reference to corrugation pattern shown in FIG. 5, in part distinguishes the pattern from the tapered flutes of corrugated media described in FIG. 1 of WO 97/40918 and WO 03/47722, incorporated herein by reference. The tapered flutes of FIG. 1 of WO 97/40918, for example, would be a curved wave pattern, but not a “regular” pattern, or a pattern of straight flutes, as the terms are used herein.

Referring to the present FIG. 5 and as referenced above, the fluted media 500 has first and second opposite edges 8 and 9. When the fluted media 500 is formed into a media pack, in general edge 9 will form an inlet end or face for the media pack and edge 8 an outlet end or face, although an opposite orientation is possible. One example of a filter element is disclosed in U.S. Pat. No. 12,257,541.

In the example depicted, the various flutes 7 extend completely between the opposite edges 8, 9, but alternatives are possible. For example, they can extend to a location adjacent or near the edges, but not completely therethrough. Also, they can be stopped and started partway through the media, as for example in the media of US 2014/0208705 A1.

When the media is as depicted in FIG. 5, adjacent edge 8 can provided a sealant bead 10, sealing the corrugated sheet 3 and the facing sheet 4 together. Bead 510 will sometimes be referred to as a “single facer” or “single face” bead, or by variants, since it is a bead between the corrugated sheet 3 and facing sheet 4, which forms the single facer (single faced) media strip 1. Sealant bead 510 seals closed individual flutes 511 adjacent edge 8, to passage of air therefrom (or thereto in an opposite flow).

In the fluted media 500 depicted in FIG. 5, adjacent edge 9 is provided seal bead 14. Seal bead 14 generally closes flutes 15 to passage of unfiltered fluid therefrom (or flow therein in an opposite flow), adjacent edge 9. Bead 14 would typically be applied as media 1 is configured into a media pack. If the media pack is made from a stack of strips 1, bead 14 will form a seal between a back side 17 of facing sheet 4, and side 18 of the next adjacent corrugated sheet 3. When the media 1 is cut in strips and stacked, instead of coiled, bead 14 is referenced as a “stacking bead.” When bead 14 is used in a coiled arrangement formed from a long strip of media 1, it may be referenced as a “winding bead.”

In alternate types of through-flow media, seal material can be located differently, and added sealant or adhesive can even be avoided. For example, in some instances, the media can be folded to form an end or edge seam; or the media can be sealed closed by alternate techniques such as ultrasound application, etc. Further, even when sealant material is used, it need not be adjacent opposite ends.

Referring to FIG. 5, once the fluted media 500 is incorporated into a media pack, for example by stacking or coiling, it can be operated as follows. First, air in the direction of arrows 512, enters open flutes 511 adjacent end 9. Due to the closure at end 8, by bead 510, the air passes through the fluted media 500, for example as shown by arrows 13. It then exits the media or media pack, by passage through open ends 15a of the flutes 15, adjacent end 8 of the media pack. Alternatively, operation could be conducted with air flow in the opposite direction.

For the particular arrangement shown herein in FIG. 5, the parallel corrugations 7a, 7b are generally straight completely across the media, from edge 8 to edge 9. Straight flutes, ridges or corrugations can be deformed or folded at selected locations, especially at ends. Modifications at flute ends for closure are generally disregarded in the above definitions of “regular,” “curved” and “wave pattern.”

Z-filter constructions which do not utilize straight, regular curved wave pattern corrugation shapes may also be used. For example, in Yamada et al. U.S. Pat. No. 5,562,825, FIGS. 1 and 3, corrugation patterns which utilize somewhat semicircular (in cross section) inlet flutes adjacent narrow V-shaped (with curved sides) exit flutes are shown. In Matsumoto, et al. U.S. Pat. No. 5,049,326, FIG. 2, circular (in cross-section) or tubular flutes defined by one sheet having half tubes attached to another sheet having half tubes, with flat regions between the resulting parallel, straight, flutes are shown. In Ishii, et al. U.S. Pat. No. 4,925,561, FIG. 1, flutes folded to have a rectangular cross section are shown, in which the flutes taper along their lengths. In WO 97/40918, FIG. 1, flutes or parallel corrugations which have a curved, wave patterns (from adjacent curved, convex and concave troughs) but which taper along their lengths (and thus are not straight) are shown. Also, in WO 97/40918 flutes which have curved wave patterns, but with different sized ridges and troughs, are shown. Also, flutes which are modified in shape to include various ridges may be used.

Typically, in the corrugation process, an inelastic deformation is caused to the media. This prevents the media from returning to its original shape. However, once the tension is released the flute or corrugations will tend to spring back, recovering only a portion of the stretch and bending that has occurred. The facing media sheet is sometimes tacked to the fluted media sheet, to inhibit this spring back in the corrugated sheet. Such tacking is shown at 520.

The embodiment depicted by FIG. 5 also includes one or more impregnates dispersed in the filter material that filters out chemical contaminants, as discussed herein with respect to FIGS. 1-4.

### Filter

FIGS. 6A and 6B illustrate exemplary embodiments of cylindrical filters 1 that include the filter element 10, 10′ of the present disclosure. The filter 1, 1′ may be formed from a sheet of fluted filter media (as illustrated in FIG. 5). According to an embodiment, the filter 1, 1′ may have a round, obround, or rectangular shaped cross-section. The filter 1, 1′ may have any suitable dimensions consistent with the shape desired. For example, the filter 1, 1 ‘may have a width, a length, and a depth, where the width and depth are perpendicular to the length. The filter 1, 1’ generally takes the shape and dimensions of the filter elements 10, 10′,20 or filter media 100, 200 that form the filter.

The filter 1, 1′ includes the filter media 100 and/or 200 described herein and, therefore, also exhibits the various chemical filtration and dust filtration properties described herein with respect to the filter media 100, 200 and filter elements (e.g., dust filtration efficiency, dust loading capacity, chemical breakthrough, etc.).

The filter 1 may include a filter element 10, as shown in FIG. 6A. The filter element 10 includes the first filter media 100 including first fibrous media 120 and a first impregnate 130. The filter element 10 may be constructed in sheets that are in a coiled or nested configuration about a central axis x on an end cap 40.

The filter 1′ may include two or more filter elements, as shown in FIG. 6B. The filter 1′ may include a first filter element 10′ and a second filter element 20. The first filter element 10′ includes the first filter media 100 including first fibrous media 120 and a first impregnate 130. The second filter element 20 includes a second filter media 200 including second fibrous media 220 and a second impregnate 230. The first and second filter elements 10′, 20 are constructed in sheets that are in a coiled or nested configuration about a central axis x on an end cap 40. The filter 1′ may include multiple layers of first and second filter elements 10′, 20 disposed on the end cap 40. For example, the filter 1′ may include multiple alternating layers of first and second filter elements 10′, 20, as shown in FIG. 6B.

In the arrangement shown in FIG. 6B, each of the first filter media 100 of the first filter element 10 abuts the adjacent second filter media 200 of the second filter element 20. In some embodiments, the first filter media 100 of the first filter element 10′ is spaced apart from the adjacent second filter media 200 of the second filter element 20. In some embodiments, the first filter media 100 of the first filter element 10′ is positioned adjacent to the second filter media 200 of the second filter element 20 such that there is a void between the first filter media 100 and the second filter media 200. In some embodiments, the first filter media 100 of the first filter element 10′ is positioned adjacent to the adjacent second filter media 200 of the second filter element 20 such that there is an intervening element or substrate (such as scrim) between the first filter media 100 and the second filter media 200. The first filter media 100 and second filter media 200 may be identical or different from one another. The first filter element 10′ and the second filter element 20 may be identical or different from one another. For example, the fibrous media or the impregnant or both may be varied between the filter elements of the filter 1′. Furthermore, while the pattern of the filter is generally illustrated that the first filter element 10′ and second filter element 20 are alternating, any suitable pattern may be utilized.

The filter 1, 1′ includes a filtration flow path 60 that extends from a first flow face 70 defined by the first filter media 100. The filter 1, 1′ may be arranged in an outside-in configuration where fluid will flow from first flow face 70 of the element toward the core 80 of the filter 1, or in an inside-out configuration where fluid will flow from the core 80 toward the first flow face 70. In such configurations, fluid flow through the filter 1, 1′ will be generally perpendicular to the longitudinal axis x. In the current example, the first flow face 70 is concentric to the core 80 of the filter, meaning that the first flow face 70 and the core 80 share a central axis x.

Further, the filter 1, 1′ may be arranged as a filter cartridge including a media pack extending between first and second end caps. The first end cap is an open end cap having an air flow aperture therethrough. The second end cap is typically a closed end cap having an outer end surface. The outer end surface in this context refers to a surface facing generally away from the first end cap. The filter cartridge may further include a housing seal arrangement for engaging an air cleaner housing.

While FIGS. 6A and 6B depict a filter 1, 1′ in a generally cylindrical configuration having a generally circular cross section, it will be appreciated that other coiled configurations are possible. In some embodiments the cross-section of the coiled media can be ovular or polygonal. Other alternative filters may include panel filters and stacked panel filters having various shapes and media configurations including fluted media, pleated media and deep pleats.

Referring now to FIGS. 7A and 7B, an exemplary embodiment of a laminated media 700 is illustrated. The laminated media 700 includes two or more layers coupled via lamination. The two or more layers may be or may include two or more of the same type of layer. The individual layers may be similar to the single-layer media shown in FIGS. 1 and 2. The laminated media may include layers of different types. In some embodiments, the laminated media 700 includes one or more layers of a first type and one or more layers of a second type, where the first and second types are different from one another. As illustrated in FIG. 7A, the laminated media 700 includes a first layer 710, which may be made of the first type, and a second layer 720, which may be made of the second type. Additional layers may be included.

In some embodiments, the first layer 710 includes a first impregnate 731 capable of binding to an acidic contaminant. In some embodiments, the first layer 710 includes a first impregnate 731 capable of binding to a basic contaminant. In some embodiments, the first layer 710 includes a first impregnate 731 capable of binding to an organic contaminant, such as a VOC contaminant, a halogenated compound, or a halogen contaminant.

In some embodiments, the second layer 720 includes a second impregnate 732 capable of binding to an acidic contaminant. In some embodiments, the second layer 720 includes a second impregnate 732 capable of binding to a basic contaminant. In some embodiments, the second layer 720 includes a second impregnate 732 capable of binding to an organic contaminant, such as a VOC contaminant, a halogenated compound, or a halogen contaminant.

In some preferred embodiments, the first impregnate 731 of the first layer 710 is of a different type than the second impregnate 732 of the second layer 720. For example, the first impregnate 731 may be capable of binding to an acidic contaminant, and the second impregnate 732 may be capable of binding to a basic contaminant. In another example, the first impregnate 731 may be capable of binding to an acidic or basic contaminant, and the second impregnate 732 may be capable of binding to an organic contaminant.

FIG. 7C is a schematic view of a lamination process, performed by a laminating system 750, for making the laminated media 700 according to an embodiment. As illustrated, a second spool 722 containing the second layer 720 is unrolled, as a first spool 712 containing the first layer 710 is unrolled. The system may further include a bonding apparatus 755. Moreover, the first spool 712 and the second spool 722, after contact, may be further processed in an oven 760. As a result of the lamination process, laminated media 700 is formed having a first layer 710 and a second layer 720. In some embodiments, the laminated media 700 is formed without the bonding apparatus 755. In some embodiments, the laminated media 700 is formed without the oven 760.

In some embodiments, the bonding apparatus 755 may apply any suitable technique for lamination of two or more layers of material. Examples of suitable techniques include applying an adhesive by spraying, rolling, printing, slot-die coating, gravure coating, or the like. In some embodiments, the bonding apparatus 755 is adhesive coating using any suitable adhesive. Examples of suitable adhesives include hot-melt adhesives, solvent-based adhesives, water-based adhesives, UV curable adhesives, pressure-sensitive adhesives, or the like. In some embodiments, the bonding apparatus 755 is arranged to apply an adhesive coating of a hot-melt adhesive.

The oven 760 may be configured to apply heat to the layers and may be any suitable oven such as a convection, vacuum, infrared, UV, or the like.

Referring now to FIGS. 8A and 8B, an exemplary embodiment of a laminated media 800 is illustrated. The laminated media 800 includes two or more layers coupled via lamination. The two or more layers may be or may include two or more of the same type of layer. The laminated media 800 may include layers of different types. The individual layers may be similar to the single-layer media shown in FIGS. 1 and 2. In some embodiments, the laminated media 800 includes one or more layers of a first type and one or more layers of a second type, where the first and second layer types are different from one another. In some embodiments, the laminated media 800 includes one of more layers of a third type, where the layer of a third type 830 is different from the first layer type and second layer type. As illustrated in FIG. 8A, the laminated media 800 includes a first layer 810, which may be made of the first type, a second layer 820, which may be made of the second type, and a third layer 830, which may be made of a third type. Additional layers may be included.

In some embodiments, the first layer 810 includes a first impregnate 811 capable of binding to an acidic component. In some embodiments, the first layer 810 includes a first impregnate 831 capable of binding to a basic component. In some embodiments, the first layer 810 includes an first impregnate 831 capable of binding to an organic contaminant, such as a VOC contaminant, a halogenated compound, or a halogen contaminant.

In some embodiments, the second layer 820 includes a second impregnate 832 capable of binding to an acidic component. In some embodiments, the second layer 820 includes a second impregnate 832 capable of binding to a basic component. In some embodiments, the second layer 820 includes a second impregnate 832 capable of binding to an organic contaminant, such as a VOC contaminant, a halogenated compound, or a halogen contaminant.

In some embodiments, the third layer 830 includes a third impregnate 833 capable of binding to an acidic contaminant. In some embodiments, the third layer 830 is a layer that includes a third impregnate 833 capable of binding to a basic contaminant. In some embodiments, the third layer 830 is a layer that includes a third impregnate 833 capable of binding to an organic contaminant, such as a VOC contaminant, a halogenated compound, or a halogen contaminant.

In some preferred embodiments, the first impregnate 831 of the first layer 810 is of a different type than the second impregnate 832 of the second layer 820 or the third impregnate 833 of the third layer 830. For examples, the first impregnate 831 may be capable of binding to an acidic contaminant, the second impregnate 832 may be capable of biding to a basic contaminant, and the third impregnate 833 may be capable of binding to a VOC contaminant. In another example, the first impregnate 831 may be capable of binding to an acidic or basic contaminant, the second impregnate 832 may be capable of biding to a VOC contaminant, and the third impregnate 833 may be capable of binding to an acidic or basic contaminant.

In some embodiments, one of the layers, such as the second layer 820, is a separation layer. The separation layer may be used to create separation between the first layer 810 and third layer 830. For example, the laminated media may be configured such that the first layer 810 includes a first impregnate capable of binding to an acidic contaminant, a second layer 820 that is a separation layer, and a third layer 830 includes a third impregnate capable of binding to a basic contaminant.

The separation layer may have a thickness of 0.10 mm or greater, 0.15 mm or greater, 0.20 mm or greater, 0.25 mm or greater, or 0.30 mm or greater. The separation layer 820 may have a thickness of 5 mm or less, 4 mm or less, 3 mm or less, 2 mm or less, 1.5 mm or less, 1.0 mm or less, 0.75 mm or less, or 0.5 mm or less. Furthermore, the separation layer may be any suitable material capable of providing adequate separation between various layers within the laminated media 800. Examples of suitable material includes non-woven, woven, fibrous, or the like.

In any of the embodiments, the laminated media 800 may include any combination of a layer of a first type, a layer of a second type, and a layer of a third type. For example, in some embodiments, the laminated media 800 may include one or more of layers of a first type, one or more of layers of a second type, and/or one or more layers of a third type. Any other suitable configuration may be contemplated, depending on the desired properties of the laminated media 800.

FIG. 8C is a schematic view of a lamination process, performed by a laminating system 750, for making the laminated media 800 according to an embodiment. As illustrated, a first spool 815 containing the first layer 810 is unrolled, a second spool 825 containing the second layer 820 is unrolled, and a third spool 835 containing the third layer 830 is unrolled. Between layers of the second type 820 and the third type 830 is a first bonding apparatus 855 and between layers of the first type 810 and the second type 820 is a second bonding apparatus 856. Furthermore, the layer of the first type 810, the layer of the second type 820, and the layer of the third type 830 may be further processed, after physical contact, in an oven 860. As a result, the laminated media 800 may be formed having a first layer 810, a second layer 820, and a third layer 830. In some embodiments, the laminated media 800 is formed without the first bonding apparatus 855 or the second bonding apparatus 856. In some embodiments, the laminated media 800 is formed without the oven 860.

In some embodiments, the first bonding apparatus 855 and the second bonding apparatus 856 may apply any suitable technique for lamination of two or more layers of material. Examples of suitable techniques include application of an adhesive by spraying, rolling, printing, slot-die coating, gravure coating, or the like. In some embodiments, the first bonding apparatus 855 or second bonding apparatus 856 are arranged to apply an adhesive coating using any suitable adhesive. Examples of suitable adhesives include hot-melt adhesives, solvent-based adhesives, water-based adhesives, UV curable adhesives, pressure-sensitive adhesives, or the like. In some embodiments, the first bonding apparatus 855 and/or the second bonding apparatus 856 is arranged to apply an adhesive coating of a hot-melt adhesive.

The oven 860 may be configured to apply heat to the layers and may be any suitable oven such as a convection oven, vacuum, infrared, UV, or the like.

### EXEMPLARY EMBODIMENTS

Embodiment 1. A filter media comprising:
a first layer comprising fibers and an impregnate capable of binding a basic contaminant or an acidic contaminant, the impregnate being present at 5 g/m² or greater by area of the filter media;
the filter media having a dust filtration efficiency of 98% or greater as measured by ISO 5011:2020 using ISO fine (A2) dust, or 15% or greater as measured by ASTM F1215-89.

Embodiment 2. The filter media of embodiment 1, wherein the filter media is configured for filtering a dust and a gaseous contaminant, wherein the gaseous contaminant comprises the basic contaminant or the acidic contaminant.

Embodiment 3. The filter media of any one of embodiments 1 or 2, wherein the filter media has a dust filtration efficiency of 20% or greater for particles having an average particle size of 0.3 μm.

Embodiment 4. The filter media of any one of embodiments 1 to 3, wherein the filter media has a dust filtration efficiency of 99.5% or greater as measured by ISO 5011:2020 using ISO fine (A2) dust.

Embodiment 5. The filter media of any one of embodiments 1 to 4, wherein the filter media further comprises a fluted sheet, a facing sheet, and a plurality of flutes formed between the fluted sheet and the facing sheet, wherein the plurality of flutes are closed to unfiltered air flowing into the filter media and the fluted sheet comprises repeating internal peaks facing toward the facing sheet and repeated external peaks facing away from the facing sheet.

Embodiment 6. The filter media of any one of embodiments 1 to 5, wherein the filter media further comprises a fluted sheet, a facing sheet, and a plurality of flutes formed between the fluted sheet and the facing sheet, wherein the plurality of flutes are closed to unfiltered air flowing into the filter media and comprising a plurality of permeable protrusions.

Embodiment 7. The filter media of any one of embodiments 1 to 6, wherein the filter media exhibits a maximum 1% breakthrough of a basic contaminant for 45 mins or greater as measured by ISO 11155-2:2009 using a basic contaminant concentration of 30 ppm, a basic contaminant flow rate of 9.1 m³/min, and at a face velocity of 3 m/s.

Embodiment 8. The filter media of any one of embodiments 1 to 6, wherein the filter media exhibits a maximum 1% breakthrough of a basic contaminant for 3 mins or greater as measured by ISO 11155-2:2009 using a basic contaminant concentration of 30 ppm, a basic contaminant flow rate of 9.1 m³/min, and at a face velocity of 3 m/s.

Embodiment 9. The filter media of any one of embodiments 1 to 8, wherein the filter media exhibits a maximum 1% breakthrough of an acidic contaminant for 22 mins or greater as measured by ISO 11155-2:2009 using an acidic contaminant concentration of 30 ppm, a basic contaminant flow rate of 9.1 m³/min, and at a face velocity of 3 m/s.

Embodiment 10. The filter media of any one of embodiments 1 to 9, wherein the filter media exhibits a maximum 10% breakthrough of a basic contaminant for 27 mins or greater as measured by ISO 11155-2:2009 using a basic contaminant concentration of 30 ppm, a basic contaminant flow rate of 9.1 m³/min, and at a face velocity of 3 m/s.

Embodiment 11. The filter media of any one of embodiments 1 to 10, wherein the filter media exhibits a maximum 10% breakthrough of an acidic contaminant for 7 mins or greater as measured by ISO 11155-2:2009 using an acidic contaminant concentration of 30 ppm, a basic contaminant flow rate of 9.1 m³/min, and at a face velocity of 3 m/s.

Embodiment 12. The filter media of any one of embodiments 1 to 11, wherein the filter media exhibits a 50% breakthrough of a basic contaminant for 60 mins or greater as measured by ISO 11155-2:2009 using a basic contaminant concentration of 30 ppm, a basic contaminant flow rate of 9.1 m³/min, and at a face velocity of 3 m/s.

Embodiment 13. The filter media of any one of embodiments 1 to 12, wherein the filter media exhibits a 50% breakthrough of an acidic contaminant for 14 mins or greater as measured by ISO 11155-2:2009 using an acidic contaminant concentration of 30 ppm, a basic contaminant flow rate of 9.1 m³/min, and at a face velocity of 3 m/s.

Embodiment 14. The filter media of any one of embodiments 1 to 13, wherein the filter media exhibits below 95% breakthrough of a basic contaminant for 972 mins or greater as measured by ISO 11155-2:2009 using a basic contaminant concentration of 30 ppm, a basic contaminant flow rate of 9.1 m³/min, and at a face velocity of 3 m/s.

Embodiment 15. The filter media of any one of embodiments 1 to 13, wherein the filter media exhibits below 95% breakthrough of a basic contaminant for 680 mins or greater as measured by ISO 11155-2:2009 using a basic contaminant concentration of 30 ppm, a basic contaminant flow rate of 9.1 m³/min, and at a face velocity of 3 m/s.

Embodiment 16. The filter media of any one of embodiments 1 to 15, wherein the filter media exhibits below 95% breakthrough of an acidic contaminant for 636 mins or greater as measured by ISO 11155-2:2009 using an acidic contaminant concentration of 30 ppm, a basic contaminant flow rate of 9.1 m³/min, and at a face velocity of 3 m/s.

Embodiment 17. The filter media of any one of embodiments 1 to 16, wherein the filter media comprises fibers having a diameter of 0.1 μm or greater.

Embodiment 18. The filter media of any one of embodiments 1 to 17, wherein the filter media comprises fibers having a diameter of 100 μm or less.

Embodiment 19. The filter media of any one of embodiments 1 to 18, wherein the filter media comprises fibers having a diameter in a range of 0.1 μm to 100 μm.

Embodiment 20. The filter media of any one of embodiments 1 to 19, wherein the filter media comprises an impregnate having a coating weight of 10 g/m² or greater, 15 g/m² or greater, 20 g/m² or greater.

Embodiment 21. The filter media of any one of embodiments 1 to 20, wherein the filter media comprises an impregnate capable of binding a basic component, the impregnate having a coating weight of 10 g/m² or greater, 15 g/m² or greater, or 20 g/m² or greater.

Embodiment 22. The filter media of any one of embodiments 1 to 21, wherein the filter media comprising an impregnate capable of binding an acidic component, the impregnate having a coating weight of 10 g/m² or greater, 15 g/m² or greater, or 20 g/m² or greater.

Embodiment 23. The filter media of any one of embodiments 1 to 22, wherein the impregnate comprises a carboxylic acid, a sulfonic acid, sulfuric acid, phosphoric acid, nitric acid, hydrochloric acid, heteropoly acid, or a combination of two or more thereof.

Embodiment 24. The filter media of any one of embodiments 1 to 22, wherein the impregnate comprises a dicarboxylic acid, a tricarboxylic acid, or an aromatic carboxylic acid, optionally wherein the impregnate comprises oxalic acid, malonic acid, citric acid, or a combination of two or more thereof.

Embodiment 25. The filter media of any one of embodiments 1 to 22, wherein the impregnate comprises a linear sulfonic acid, a cyclic sulfonic acid, an aromatic sulfonic acid, or a combination of two or more thereof.

Embodiment 26. The filter media of any one of embodiments 1 to 25, wherein the impregnate comprises potassium carbonate, potassium iodide, tributyl ammonium hydroxide, sodium hydroxide, piperidine, piperazine, heterocyclic amine, or a combination of two or more thereof.

Embodiment 27. The filter media of any one of embodiments 1 to 26, wherein the impregnate is free of activated carbon.

Embodiment 28. The filter media of any one of embodiments 1 to 27, wherein the impregnate is present in the filter media at 160 g/m² or less.

Embodiment 29. The filter media of any one of embodiments 1 to 28, wherein the fibers of the filter media comprise cellulose fibers, synthetic fibers, glass fibers, or a combination of two or more thereof.

Embodiment 30. The filter media of any one of embodiments 1 to 29, wherein the filter media has a basis weight of 1 g/m² or greater.

Embodiment 31. The filter media of any one of embodiments 1 to 30, wherein the filter media has a basis weight of 500 g/m² or less.

Embodiment 32. The filter media of any one of embodiments 1 to 31, wherein the filter media has a basis weight in a range of 1 g/m² to 500 g/m².

Embodiment 33. The filter media of any one of embodiments 1 to 32, wherein the filter media has a density of 80 kg/m³ or greater.

Embodiment 34. The filter media of any one of embodiments 1 to 33, wherein the filter media has a density of 550 kg/m³ or less.

Embodiment 35. The filter media of any one of embodiments 1 to 34, wherein the filter media has a density in a range of 80 kg/m³ to 550 kg/m³.

Embodiment 36. The filter media of any one of embodiments 1 to 35, comprising a laminated media comprising two or more of the first layer.

Embodiment 37. The filter media of embodiment 36, wherein the laminated media comprises a plurality of the first layer coupled via lamination.

Embodiment 38. The filter media of embodiment 37, wherein the lamination comprises an adhesive, optionally wherein the adhesive comprises a hot melt adhesive.

Embodiment 39. The filter media of any one of embodiments 36 to 38, further comprising one or more of a second layer that is different from the first layer.

Embodiment 40. The filter media of embodiment 39, wherein the second layer is a separation layer.

Embodiment 41. The filter media of embodiment 40, wherein the second layer has a thickness of 0.15 mm or greater.

Embodiment 42. A filter media comprising a laminated media comprising:
two or more first layers, each first layer comprising fibers and an impregnate capable of binding a basic contaminant or an acidic contaminant, the impregnate being present at 5 g/m² or greater by area of the filter media;
the filter media having a dust filtration efficiency of 98% or greater as measured by ISO 5011:2020 using ISO fine (A2) dust, or 15% or greater as measured by ASTM F1215-89.

Embodiment 43. The filter media of embodiment 42, wherein the two or more layers are coupled via lamination.

Embodiment 44. The filter media of embodiment 43, wherein the lamination comprises an adhesive, optionally wherein the adhesive comprises a hot melt adhesive.

Embodiment 45. The filter media of any one of embodiments 42 to 44, further comprising one or more of a second layer that is different from the first layers.

Embodiment 46. The filter media of embodiment 39, wherein the second layer is a separation layer.

Embodiment 47. The filter media of embodiment 40, wherein the second layer has a thickness of 0.15 mm or greater.

Embodiment 48. The filter media of embodiment 42, wherein the filter media is configured for filtering a dust and a gaseous contaminant, wherein the gaseous contaminant comprises the basic contaminant or the acidic contaminant.

Embodiment 49. The filter media of any one of embodiments 42 to 48, wherein the filter media has a dust filtration efficiency of 20% or greater for particles having an average particle size of 0.3 μm.

Embodiment 50. The filter media of any one of embodiments 42 to 49, wherein the filter media has a dust filtration efficiency of 99.5% or greater as measured by ISO 5011:2020 using ISO fine (A2) dust.

Embodiment 51. The filter media of any one of embodiments 42 to 50, wherein the filter media further comprises a fluted sheet, a facing sheet, and a plurality of flutes formed between the fluted sheet and the facing sheet, wherein the plurality of flutes are closed to unfiltered air flowing into the filter media and the fluted sheet comprises repeating internal peaks facing toward the facing sheet and repeated external peaks facing away from the facing sheet.

Embodiment 52. The filter media of any one of embodiments 42 to 51, wherein the filter media further comprises a fluted sheet, a facing sheet, and a plurality of flutes formed between the fluted sheet and the facing sheet, wherein the plurality of flutes are closed to unfiltered air flowing into the filter media and comprising a plurality of permeable protrusions.

Embodiment 53. The filter media of any one of embodiments 42 to 52, wherein the filter media exhibits a maximum 1% breakthrough of a basic contaminant for 45 mins or greater as measured by ISO 11155-2:2009 using a basic contaminant concentration of 30 ppm, a basic contaminant flow rate of 9.1 m³/min, and at a face velocity of 3 m/s.

Embodiment 54. The filter media of any one of embodiments 42 to 53, wherein the filter media exhibits a maximum 1% breakthrough of a basic contaminant for 3 mins or greater as measured by ISO 11155-2:2009 using a basic contaminant concentration of 30 ppm, a basic contaminant flow rate of 9.1 m³/min, and at a face velocity of 3 m/s.

Embodiment 55. The filter media of any one of embodiments 42 to 54, wherein the filter media exhibits a maximum 1% breakthrough of an acidic contaminant for 22 mins or greater as measured by ISO 11155-2:2009 using an acidic contaminant concentration of 30 ppm, a basic contaminant flow rate of 9.1 m³/min, and at a face velocity of 3 m/s.

Embodiment 56. The filter media of any one of embodiments 42 to 55, wherein the filter media exhibits a maximum 10% breakthrough of a basic contaminant for 27 mins or greater as measured by ISO 11155-2:2009 using a basic contaminant concentration of 30 ppm, a basic contaminant flow rate of 9.1 m³/min, and at a face velocity of 3 m/s.

Embodiment 57. The filter media of any one of embodiments 42 to 56, wherein the filter media exhibits a maximum 10% breakthrough of an acidic contaminant for 7 mins or greater as measured by ISO 11155-2:2009 using an acidic contaminant concentration of 30 ppm, a basic contaminant flow rate of 9.1 m³/min, and at a face velocity of 3 m/s.

Embodiment 58. The filter media of any one of embodiments 42 to 57, wherein the filter media exhibits a 50% breakthrough of a basic contaminant for 60 mins or greater as measured by ISO 11155-2:2009 using a basic contaminant concentration of 30 ppm, a basic contaminant flow rate of 9.1 m³/min, and at a face velocity of 3 m/s.

Embodiment 59. The filter media of any one of embodiments 42 to 58, wherein the filter media exhibits a 50% breakthrough of an acidic contaminant for 14 mins or greater as measured by ISO 11155-2:2009 using an acidic contaminant concentration of 30 ppm, a basic contaminant flow rate of 9.1 m³/min, and at a face velocity of 3 m/s.

Embodiment 60. The filter media of any one of embodiments 42 to 59, wherein the filter media exhibits below 95% breakthrough of a basic contaminant for 972 mins or greater as measured by ISO 11155-2:2009 using a basic contaminant concentration of 30 ppm, a basic contaminant flow rate of 9.1 m³/min, and at a face velocity of 3 m/s.

Embodiment 61. The filter media of any one of embodiments 42 to 60, wherein the filter media exhibits below 95% breakthrough of a basic contaminant for 680 mins or greater as measured by ISO 11155-2:2009 using a basic contaminant concentration of 30 ppm, a basic contaminant flow rate of 9.1 m³/min, and at a face velocity of 3 m/s.

Embodiment 62. The filter media of any one of embodiments 42 to 61, wherein the filter media exhibits below 95% breakthrough of an acidic contaminant for 636 mins or greater as measured by ISO 11155-2:2009 using an acidic contaminant concentration of 30 ppm, a basic contaminant flow rate of 9.1 m³/min, and at a face velocity of 3 m/s.

Embodiment 63. The filter media of any one of embodiments 42 to 62, wherein the filter media comprises fibers having a diameter of 0.1 μm or greater.

Embodiment 64. The filter media of any one of embodiments 42 to 63, wherein the filter media comprises fibers having a diameter of 100 μm or less.

Embodiment 65. The filter media of any one of embodiments 42 to 64, wherein the filter media comprises fibers having a diameter in a range of 0.1 μm to 100 μm.

Embodiment 66. The filter media of any one of embodiments 42 to 65, wherein the filter media comprises an impregnate having a coating weight of 10 g/m² or greater, 15 g/m² or greater, 20 g/m² or greater.

Embodiment 67. The filter media of any one of embodiments 42 to 66, wherein the filter media comprises an impregnate capable of binding a basic component, the impregnate having a coating weight of 10 g/m² or greater, 15 g/m² or greater, or 20 g/m² or greater.

Embodiment 68. The filter media of any one of embodiments 42 to 67, wherein the filter media comprises an impregnate capable of binding an acidic component, the impregnate having a coating weight of 10 g/m² or greater, 15 g/m² or greater, or 20 g/m² or greater.

Embodiment 69. The filter media of any one of embodiments 42 to 68, wherein the impregnate comprises a carboxylic acid, a sulfonic acid, sulfuric acid, phosphoric acid, nitric acid, hydrochloric acid, heteropoly acid, or a combination of two or more thereof.

Embodiment 70. The filter media of any one of embodiments 42 to 69, wherein the impregnate comprises a dicarboxylic acid, a tricarboxylic acid, or an aromatic carboxylic acid, optionally wherein the impregnate comprises oxalic acid, malonic acid, citric acid, or a combination of two or more thereof.

Embodiment 71. The filter media of any one of embodiments 42 to 70, wherein the impregnate comprises a linear sulfonic acid, a cyclic sulfonic acid, an aromatic sulfonic acid, or a combination of two or more thereof.

Embodiment 72. The filter media of any one of embodiments 42 to 71, wherein the impregnate comprises potassium carbonate, potassium iodide, tributyl ammonium hydroxide, sodium hydroxide, piperidine, piperazine, heterocyclic amine, or a combination of two or more thereof.

Embodiment 73. The filter media of any one of embodiments 42 to 72, wherein the impregnate is free of activated carbon.

Embodiment 74. The filter media of any one of embodiments 42 to 73, wherein the impregnate is present in the filter media at 160 g/m² or less.

Embodiment 75. The filter media of any one of embodiments 42 to 74, wherein the fibers of the filter media comprise cellulose fibers, synthetic fibers, glass fibers, or a combination of two or more thereof.

Embodiment 76. The filter media of any one of embodiments 42 to 75, wherein the filter media has a basis weight of 1 g/m² or greater.

Embodiment 77. The filter media of any one of embodiments 42 to 76, wherein the filter media has a basis weight of 500 g/m² or less.

Embodiment 78. The filter media of any one of embodiments 42 to 77, wherein the filter media has a basis weight in a range of 1 g/m² to 500 g/m².

Embodiment 79. The filter media of any one of embodiments 42 to 78, wherein the filter media has a density of 80 kg/m³ or greater.

Embodiment 80. The filter media of any one of embodiments 42 to 79, wherein the filter media has a density of 550 kg/m³ or less.

Embodiment 81. The filter media of any one of embodiments 42 to 80, wherein the filter media has a density in a range of 80 kg/m³ to 550 kg/m³.

Embodiment 82. A filter element comprising:
a media pack having an inlet end and an outlet end, the media pack comprising:
a first layer comprising fibers and an impregnate capable of binding a basic contaminant or an acidic contaminant, the impregnate being present at 5 g/m² or greater by area of the media pack;
the media pack having a dust filtration efficiency of 98% or greater as measured by ISO 5011:2020 using ISO fine (A2) dust, or 15% or greater as measured by ASTM F1215-89.

Embodiment 83. The filter element of embodiment 82, wherein the media pack has a width, a length, and a depth, wherein the width and the length are perpendicular to the depth, and the width is in a range of 50 mm to 800 mm.

Embodiment 84. The filter element of any one of embodiments 82 or 83, wherein the media pack has a width, a length, and a depth, wherein the width and the length are perpendicular to the depth, and the length is in a range of 50 mm to 800 mm.

Embodiment 85. The filter element of any one of embodiments 82 to 84, wherein the media pack has a width, a length, and a depth, wherein the width and the length are perpendicular to the depth, and the depth is in a range of 10 mm to 400 mm.

Embodiment 86. The filter element of any one of embodiments 82 to 85, wherein the media pack is configured for filtering a dust and a gaseous contaminant, wherein the gaseous contaminant comprises the basic contaminant or the acidic contaminant.

Embodiment 87. The filter element of any one of embodiments 82 to 86, wherein the media pack has a dust filtration efficiency of 20% or greater for particles having an average particle size of 0.3 μm.

Embodiment 88. The filter element of any one of embodiments 82 to 87, wherein the media pack has a dust filtration efficiency of 99.5% or greater as measured by ISO 5011:2020 using ISO fine (A2) dust.

Embodiment 89. The filter element of any one of embodiments 82 to 88, wherein the media pack further comprises a fluted sheet, a facing sheet, and a plurality of flutes formed between the fluted sheet and the facing sheet, wherein the plurality of flutes are closed to unfiltered air flowing into the media pack and the fluted sheet comprises repeating internal peaks facing toward the facing sheet and repeated external peaks facing away from the facing sheet.

Embodiment 90. The filter element of any one of embodiments 82 to 89, wherein the media pack further comprises a fluted sheet, a facing sheet, and a plurality of flutes formed between the fluted sheet and the facing sheet, wherein the plurality of flutes are closed to unfiltered air flowing into the media pack and comprising a plurality of permeable protrusions.

Embodiment 91. The filter element of any one of embodiments 89 or 90, wherein the plurality of flutes have a round, obround, or rectangular shaped cross-section.

Embodiment 92. The filter element of any one of embodiments 82 to 91, wherein the media pack exhibits a maximum 1% breakthrough of a basic contaminant for 45 mins or greater as measured by ISO 11155-2:2009 using a basic contaminant concentration of 30 ppm, a basic contaminant flow rate of 9.1 m³/min, and at a face velocity of 3 m/s.

Embodiment 93. The filter element of any one of embodiments 82 to 92, wherein the media pack exhibits a maximum 1% breakthrough of a basic contaminant for 3 mins or greater as measured by ISO 11155-2:2009 using a basic contaminant concentration of 30 ppm, a basic contaminant flow rate of 9.1 m³/min, and at a face velocity of 3 m/s.

Embodiment 94. The filter element of any one of embodiments 82 to 93, wherein the media pack exhibits a maximum 1% breakthrough of an acidic contaminant for 22 mins or greater as measured by ISO 11155-2:2009 using an acidic contaminant concentration of 30 ppm, a basic contaminant flow rate of 9.1 m³/min, and at a face velocity of 3 m/s.

Embodiment 95. The filter element of any one of embodiments 82 to 94, wherein the media pack exhibits a maximum 10% breakthrough of a basic contaminant for 27 mins or greater as measured by ISO 11155-2:2009 using a basic contaminant concentration of 30 ppm, a basic contaminant flow rate of 9.1 m³/min, and at a face velocity of 3 m/s.

Embodiment 96. The filter element of any one of embodiments 82 to 95, wherein the media pack exhibits a maximum 10% breakthrough of an acidic contaminant for 7 mins or greater as measured by ISO 11155-2:2009 using an acidic contaminant concentration of 30 ppm, a basic contaminant flow rate of 9.1 m³/min, and at a face velocity of 3 m/s.

Embodiment 97. The filter element of any one of embodiments 82 to 96, wherein the media pack exhibits a 50% breakthrough of a basic contaminant for 60 mins or greater as measured by ISO 11155-2:2009 using a basic contaminant concentration of 30 ppm, a basic contaminant flow rate of 9.1 m³/min, and at a face velocity of 3 m/s.

Embodiment 98. The filter element of any one of embodiments 82 to 97, wherein the media pack exhibits a 50% breakthrough of an acidic contaminant for 14 mins or greater as measured by ISO 11155-2:2009 using an acidic contaminant concentration of 30 ppm, a basic contaminant flow rate of 9.1 m³/min, and at a face velocity of 3 m/s.

Embodiment 99. The filter element of any one of embodiments 82 to 98, wherein the media pack exhibits below 95% breakthrough of a basic contaminant for 972 mins or greater as measured by ISO 11155-2:2009 using a basic contaminant concentration of 30 ppm, a basic contaminant flow rate of 9.1 m³/min, and at a face velocity of 3 m/s.

Embodiment 100. The filter element of any one of embodiments 82 to 99, wherein the media pack exhibits below 95% breakthrough of a basic contaminant for 680 mins or greater as measured by ISO 11155-2:2009 using a basic contaminant concentration of 30 ppm, a basic contaminant flow rate of 9.1 m³/min, and at a face velocity of 3 m/s.

Embodiment 101. The filter element of any one of embodiments 82 to 100, wherein the media pack exhibits below 95% breakthrough of an acidic contaminant for 636 mins or greater as measured by ISO 11155-2:2009 using an acidic an acidic contaminant concentration of 30 ppm, a basic contaminant flow rate of 9.1 m³/min, and at a face velocity of 3 m/s.

Embodiment 102. The filter element of any one of embodiments 82 to 101, wherein the media pack comprises fibers having a diameter of 0.1 μm or greater.

Embodiment 103. The filter element of any one of embodiments 82 to 102, wherein the media pack comprises fibers having a diameter of 100 μm or less.

Embodiment 104. The filter element of any one of embodiments 82 to 103, wherein the media pack comprises fibers having a diameter in a range of 0.1 μm to 100 μm.

Embodiment 105. The filter element of any one of embodiments 82 to 104, wherein the media pack comprises an impregnate having a coating weight of 10 g/m² or greater, 15 g/m² or greater, or 20 g/m² or greater.

Embodiment 106. The filter element of any one of embodiments 82 to 105, wherein the media pack comprises an impregnate capable of binding a basic component, the impregnate having a coating weight of 10 g/m² or greater, 15 g/m² or greater, or 20 g/m² or greater.

Embodiment 107. The filter element of any one of embodiments 82 to 106, wherein the media pack comprising an impregnate capable of binding an acidic component, the impregnate having coating weight of 10 g/m² or greater, 15 g/m² or greater, or 20 g/m² or greater.

Embodiment 108. The filter element of any one of embodiments 82 to 107, wherein the impregnate comprises a carboxylic acid, a sulfonic acid, sulfuric acid, phosphoric acid, nitric acid, hydrochloric acid, heteropoly acid, or a combination of two or more thereof.

Embodiment 109. The filter element of any one of embodiments 82 to 108, wherein the impregnate comprises a dicarboxylic acid, a tricarboxylic acid, or an aromatic carboxylic acid, optionally wherein the impregnate comprises oxalic acid, malonic acid, citric acid, or a combination of two or more thereof.

Embodiment 110. The filter element of any one of embodiments 82 to 109, wherein the impregnate comprises a linear sulfonic acid, a cyclic sulfonic acid, an aromatic sulfonic acid, or a combination of two or more thereof.

Embodiment 111. The filter element of any one of embodiments 82 to 110, wherein the impregnate comprises potassium carbonate, potassium iodide, tributyl ammonium hydroxide, sodium hydroxide, piperidine, piperazine, heterocyclic amine, or a combination of two or more thereof.

Embodiment 112. The filter element of any one of embodiments 82 to 111, wherein the impregnate is free of activated carbon.

Embodiment 113. The filter element of any one of embodiments 82 to 112, wherein the impregnate is present in the media pack at 160 g/m² or less.

Embodiment 114. The filter element of any one of embodiments 82 to 113, wherein the fibers of the media pack comprise cellulose fibers, synthetic fibers, glass fibers, or a combination of two or more thereof.

Embodiment 115. The filter element of any one of embodiments 82 to 114, wherein the media pack has a basis weight of 1 g/m² or greater.

Embodiment 116. The filter element of any one of embodiments 82 to 115, wherein the media pack has a basis weight of 500 g/m² or less.

Embodiment 117. The filter element of any one of embodiments 82 to 116, wherein the media pack has a basis weight in a range of 1 g/m² to 500 g/m².

Embodiment 118. The filter element of any one of embodiments 82 to 117, wherein the media pack has a density of 80 kg/m³ or greater.

Embodiment 119. The filter element of any one of embodiments 82 to 118, wherein the media pack has a density of 550 kg/m³ or less.

Embodiment 120. The filter element of any one of embodiments 82 to 119, wherein the media pack has a density in a range of 80 kg/m³ to 550 kg/m³.

Embodiment 121. The filter element of any one of embodiments 82 to 120, comprising a laminated media comprising two or more of the first layer.

Embodiment 122. The filter element of embodiment 82, wherein the laminated media comprises a plurality of the first layer coupled via lamination.

Embodiment 123. The filter element of embodiment 122, wherein the lamination comprises an adhesive, optionally wherein the adhesive comprises a hot melt adhesive.

Embodiment 124. The filter element of any one of embodiments 82 to 123, further comprising one or more of a second layer that is different from the first layer.

Embodiment 125. The filter element of embodiment 124, wherein the second layer is a separation layer.

Embodiment 126. The filter element of embodiment 125, wherein the second layer has a thickness of 0.15 mm or greater.

Embodiment 127. A filter comprising:
a first filter element comprising a first filter media comprising a layer comprising fibers and a first impregnate, the first impregnate being present at 5 g/m² or greater by area of the first filter media; the first filter media having a dust filtration efficiency of 98% or greater as measured by ISO 5011:2020 using ISO fine (A2) dust, or 15% or greater as measured by ASTM F1215-89;
a second filter element comprising a second filter media comprising a layer comprising fibers and a second impregnate, the second impregnate being present at 5 g/m² or greater by area of the second filter media; the second filter media having a dust filtration efficiency of 98% or greater as measured by ISO 5011:2020 using ISO fine (A2) dust, or 15% or greater as measured by ASTM F1215-89;
the first filter element and the second filter element being independently capable of binding a basic contaminant, an acidic contaminant, or a VOC, wherein at least one of the first filter element and the second filter element is capable of binding a basic contaminant or an acidic contaminant.

Embodiment 128. The filter of embodiment 127, wherein the filter further comprises a third filter element comprising a layer comprising fibers and a third impregnate, the third impregnate being present at 5 g/m² or greater by area of the filter media; the third filter media having a dust filtration efficiency of 98% or greater as measured by ISO 5011:2020 using ISO fine (A2) dust, or 15% or greater as measured by ASTM F1215-89.

Embodiment 129. The filter of embodiment 128, wherein the third filter element is independently capable of binding a basic contaminant, an acidic contaminant, or a VOC.

Embodiment 130. The filter of any one of embodiments 127 to 129, wherein at least one of the first filter element and the second filter element have a width, a length, and a depth, wherein the width and the length are perpendicular to the depth, and the width is in a range of 50 mm to 800 mm.

Embodiment 131. The filter of any one of embodiments 127 to 130, wherein at least one of the first filter element and the second filter element have a width, a length, and a depth, wherein the width and the length are perpendicular to the depth, and the length is in a range of 50 mm to 800 mm.

Embodiment 132. The filter of any one of embodiments 127 to 131, wherein at least one of the first filter element and the second filter element have a width, a length, and a depth, wherein the width and the length are perpendicular to the depth, and the depth is in a range of 10 mm to 400 mm.

Embodiment 133. The filter of any one of embodiments 127 to 132, wherein at least one of the first filter media and the second filter media are configured for filtering a dust and a gaseous contaminant, wherein the gaseous contaminant comprises the basic contaminant or the acidic contaminant.

Embodiment 134. The filter of any one of embodiments 127 to 133, wherein at least one of the first filter media and the second filter media are a dust filtration efficiency of 20% or greater for particles having an average particle size of 0.3 μm.

Embodiment 135. The filter of any one of embodiments 127 to 134, wherein at least one of the first filter media and the second filter media have a dust filtration efficiency of 99.5% or greater as measured by ISO 5011:2020 using ISO fine (A2) dust.

Embodiment 136. The filter of any one of embodiments 127 to 135, wherein at least one of the first filter media and the second filter media further comprise a fluted sheet, a facing sheet, and a plurality of flutes formed between the fluted sheet and the facing sheet, wherein the plurality of flutes are closed to unfiltered air flowing into the filter media and the fluted sheet comprises repeating internal peaks facing toward the facing sheet and repeated external peaks facing away from the facing sheet.

Embodiment 137. The filter of any one of embodiments 127 to 136, wherein at least one of the first filter media and the second filter media further comprise a fluted sheet, a facing sheet, and a plurality of flutes formed between the fluted sheet and the facing sheet, wherein the plurality of flutes are closed to unfiltered air flowing into the filter media and comprising a plurality of permeable protrusions.

Embodiment 138. The filter of any one of embodiments 136 or 137, wherein the plurality of flutes of at least one of the first filter media and the second filter media have a round, obround, or rectangular shaped cross-section.

Embodiment 139. The filter of any one of embodiments 127 to 138, wherein at least one of the first filter media and the second filter media exhibit a maximum 1% breakthrough of a basic contaminant for 45 mins or greater as measured by ISO 11155-2:2009 using a basic contaminant concentration of 30 ppm, a basic contaminant flow rate of 9.1 m³/min, and at a face velocity of 3 m/s.

Embodiment 140. The filter of any one of embodiments 127 to 139, wherein at least one of the first filter media and the second filter media exhibit a maximum 1% breakthrough of a basic contaminant for 3 mins or greater as measured by ISO 11155-2:2009 using a basic contaminant concentration of 30 ppm, a basic contaminant flow rate of 9.1 m³/min, and at a face velocity of 3 m/s.

Embodiment 141. The filter of any one of embodiments 127 to 140, wherein at least one of the first filter media and the second filter media exhibit a maximum 1% breakthrough of an acidic contaminant for 22 mins or greater as measured by ISO 11155-2:2009 using a basic contaminant concentration of 30 ppm, an acidic contaminant flow rate of 9.1 m³/min, and at a face velocity of 3 m/s.

Embodiment 142. The filter of any one of embodiments 127 to 141, wherein at least one of the first filter media and the second filter media exhibit a maximum 10% breakthrough of a basic contaminant for 27 mins or greater as measured by ISO 11155-2:2009 using a basic contaminant concentration of 30 ppm, a basic contaminant flow rate of 9.1 m³/min, and at a face velocity of 3 m/s.

Embodiment 143. The filter of any one of embodiments 127 to 142, wherein at least one of the first filter media and the second filter media exhibit a maximum 10% breakthrough of an acidic contaminant for 7 mins or greater as measured by ISO 11155-2:2009 using a basic contaminant concentration of 30 ppm, an acidic contaminant flow rate of 9.1 m³/min, and at a face velocity of 3 m/s.

Embodiment 144. The filter of any one of embodiments 127 to 143, wherein at least one of the first filter media and the second filter media exhibit a 50% breakthrough of a basic contaminant for 60 mins or greater as measured by ISO 11155-2:2009 using a basic contaminant concentration of 30 ppm, a basic contaminant flow rate of 9.1 m³/min, and at a face velocity of 3 m/s.

Embodiment 145. The filter of any one of embodiments 127 to 144, wherein at least one of the first filter media and the second filter media exhibit a 50% breakthrough of an acidic contaminant for 14 mins or greater as measured by ISO 11155-2:2009 using a basic contaminant concentration of 30 ppm, an acidic contaminant flow rate of 9.1 m³/min, and at a face velocity of 3 m/s.

Embodiment 146. The filter of any one of embodiments 127 to 145, wherein at least one of the first filter media and the second filter media exhibit below 95% breakthrough of a basic contaminant for 972 mins or greater as measured by ISO 11155-2:2009 using a basic contaminant concentration of 30 ppm, a basic contaminant flow rate of 9.1 m³/min, and at a face velocity of 3 m/s.

Embodiment 147. The filter of any one of embodiments 127 to 146, wherein at least one of the first filter media and the second filter media exhibit below 95% breakthrough of a basic contaminant for 680 mins or greater as measured by ISO 11155-2:2009 using a basic contaminant concentration of 30 ppm, a basic contaminant flow rate of 9.1 m³/min, and at a face velocity of 3 m/s.

Embodiment 148. The filter of any one of embodiments 127 to 147, wherein at least one of the first filter media and the second filter media exhibit below 95% breakthrough of an acidic contaminant for 636 mins or greater as measured by ISO 11155-2:2009 using a basic contaminant concentration of 30 ppm, an acidic contaminant flow rate of 9.1 m³/min, and at a face velocity of 3 m/s

Embodiment 149. The filter of any one of embodiments 127 to 148, wherein at least one of the first filter media and the second filter media comprise fibers having a diameter of 0.1 μm or greater.

Embodiment 150. The filter of any one of embodiments 127 to 149, wherein at least one of the first filter media and the second filter media comprise fibers having a diameter of 100 μm or less.

Embodiment 151. The filter of any one of embodiments 127 to 150, wherein at least one of the first filter media and the second filter media comprise fibers having a diameter in a range of 0.1 μm to 100 μm.

Embodiment 152. The filter of any one of embodiments 127 to 151, wherein the first filter media comprise an impregnate having a coating weight of 10 g/m² or greater, 15 g/m² or greater, or 20 g/m² or greater.

Embodiment 153. The filter of any one of embodiments 127 to 152, wherein the second filter media comprise an impregnate having a coating weight of 10 g/m² or greater, 15 g/m² or greater, or 20 g/m² or greater.

Embodiment 154. The filter of any one of embodiments 127 to 153, wherein the first filter media comprises a first impregnate capable of binding a basic component, the first impregnate having a coating weight of 10 g/m² or greater, 15 g/m² or greater, or 20 g/m² or greater.

Embodiment 155. The filter of any one of embodiments 127 to 154, wherein the second filter media comprises a second impregnate capable of binding a basic component, the second impregnate having a coating weight of 10 g/m² or greater, 15 g/m² or greater, or 20 g/m² or greater.

Embodiment 156. The filter of any one of embodiments 127 to 155, wherein the first filter media comprises a first impregnate capable of binding an acidic component, the first impregnate having a coating weight of 10 g/m² or greater, 15 g/m² or greater, or 20 g/m² or greater.

Embodiment 157. The filter of any one of embodiments 127 to 156, wherein the second filter media comprises a second impregnate capable of binding an acidic component, the second impregnate having a coating weight of 10 g/m² or greater, 15 g/m² or greater, or 20 g/m² or greater.

Embodiment 158. The filter of any one of embodiments 127 to 157, wherein at least one of the first impregnate and the second impregnate comprise a carboxylic acid, a sulfonic acid, sulfuric acid, phosphoric acid, nitric acid, hydrochloric acid, heteropoly acid, or a combination of two or more thereof.

Embodiment 159. The filter of any one of embodiments 127 to 158, wherein at least one of the first impregnate and the second impregnate comprise a dicarboxylic acid, a tricarboxylic acid, or an aromatic carboxylic acid, optionally wherein the first impregnate and the second impregnate comprises oxalic acid, malonic acid, citric acid, or a combination of two or more thereof.

Embodiment 160. The filter of any one of embodiments 127 to 159, wherein at least one of the first impregnate and the second impregnate comprise a linear sulfonic acid, a cyclic sulfonic acid, an aromatic sulfonic acid, or a combination of two or more thereof.

Embodiment 161. The filter of any one of embodiments 127 to 160, wherein at least one of the first impregnate and the second impregnate comprise potassium carbonate, potassium iodide, tributyl ammonium hydroxide, sodium hydroxide, piperidine, piperazine, heterocyclic amine, or a combination of two or more thereof.

Embodiment 162. The filter of any one of embodiments 127 to 161, wherein at least one of the first impregnate and the second impregnate comprise are free of activated carbon.

Embodiment 163. The filter of any one of embodiments 127 to 162, wherein at least one of the first impregnate and the second impregnate comprise are present in the filter media at 160 g/m² or less.

Embodiment 164. The filter of any one of embodiments 127 to 163, wherein the fibers of at least one of the first filter media and the second filter media comprise cellulose fibers, synthetic fibers, glass fibers, or a combination of two or more thereof.

Embodiment 165. The filter of any one of embodiments 127 to 164, wherein at least one of the first filter media and the second filter media have a basis weight of 1 g/m² or greater.

Embodiment 166. The filter of any one of embodiments 127 to 165, wherein at least one of the first filter media and the second filter media have a basis weight of 500 g/m² or less.

Embodiment 167. The filter of any one of embodiments 127 to 166, wherein at least one of the first filter media and the second filter media have a basis weight in a range of 1 g/m² to 500 g/m².

Embodiment 168. The filter of any one of embodiments 127 to 167, wherein at least one of the first filter media and the second filter media have a density of 80 kg/m³ or greater.

Embodiment 169. The filter of any one of embodiments 127 to 168, wherein at least one of the first filter media and the second filter media have a density of 550 kg/m³ or less.

Embodiment 170. The filter of any one of embodiments 127 to 169, wherein at least one of the first filter media and the second filter media have a density in a range of 80 kg/m³ to 550 kg/m³.

Embodiment 171. A method of filtering air, the method comprising:
passing an airflow through a filter comprising a filter media comprising:
   a first layer comprising fibers and an impregnate capable of binding a basic contaminant or an acidic contaminant, the impregnate being present at 5 g/m² or greater by area of the filter media;
   the filter media having a dust filtration efficiency of 98% or greater as measured by ISO 5011:2020 using ISO fine (A2) dust, or 15% or greater as measured by ASTM F1215-89.

Embodiment 172. The method of embodiment 171, wherein the filter media having a dust loading capacity of 350 g or greater measured at a face velocity of 3 m/s and a depth of 100 mm.

Embodiment 173. The method of any one of embodiments 171 or 172, wherein the airflow is an intake airflow of a fuel cell.

Embodiment 174. The filter media, filter element, filter, or method of any one of the preceding embodiments, wherein the impregnate capable of binding a basic contaminant comprises saturated, unsaturated, or aromatic-containing dicarboxylic acids (e.g., oxalic, malonic, succinic, glutaric, adipic, maleic, or fumaric acid, etc.); saturated, unsaturated, or aromatic-containing tricarboxylic acids (citric, aconitic, propane-1,2,3-tricarboxylic, or trimesic acid, etc.); saturated, unsaturated, or aromatic-containing multi-acids; boric acid; poly(meth)acrylic acid or other polymers containing carboxylic acid functionalities; sulfuric acid, phosphoric acid, nitric acid, hydrochloric acid; benzenesulfonic acid or other small molecule sulfonic acids, poly(styrenesulfonic acid) or other polymers containing sulfonic acid functionalities; silica gel (silicon dioxide/modified silicon dioxide); zeolites, molecular sieves, aluminosilicates; ion-exchange resins, or a combination of two or more thereof.

Embodiment 175. The filter media, filter element, filter, or method of any one of the preceding embodiments, wherein the impregnate capable of binding an acidic contaminant comprises sodium carbonate, sodium bicarbonate, potassium carbonate, potassium bicarbonate, calcium carbonate, calcium bicarbonate; sodium hydroxide, potassium hydroxide, calcium hydroxide, lithium hydroxide; sodium metabisulfite, potassium metabisulfite; metal oxides; sodium silicate, potassium silicate; quaternary ammonium salts and polymers containing quaternary ammonium salts; silica gel (silicon dioxide/modified silicon dioxide); zeolites, molecular sieves, aluminosilicates; ion-exchange resins, or a combination of two or more thereof.

### EXAMPLES

### Example 1

Various samples of fibrous filter media consistent with the present disclosure were tested herein for dust filtration efficiency. Dust filtration efficiency generally determines the retention capabilities of the fibrous filter media when exposed to coarse dust or a fine dust at a constant or variable air flow.

Control was prepared using commercially available cellulose-based filter media, available as POWERCORE® from Donaldson Company, Inc. in Minneapolis, MN.

Samples 1-3 were prepared using the same fibrous filter media as the Control.

Sample 1 used filter media configured with geometry as described in U.S. Pat. No. 7,959,702. Samples 2 and 3 used filter media configured with geometries as described in U.S. Pat. No. 9,623,362.

Samples 1-3 were further processed to include an impregnate. To impregnate each of Samples 1-3, a solution of an acid or base impregnate and a preservative was prepared. The fibrous filter media was dipped in the solution until the solution was substantially dispersed in the fibrous filter media, forming a saturated fibrous filter media. Next the saturated fibrous filter media was dried in an oven until any liquid present was evaporated off leaving the solid impregnate and preservative behind substantially dispersed in the fibrous filter media.

Samples 1-3 were impregnated with 35% citric acid and 0.5% sodium benzoate.

Samples 1-3 were tested according to the ISO-5011 2020 full life efficiency test as described in section 6.4.2 of the standard. The dust used is A2 fine dust as described in ISO 12103-1 (2024).

TABLE 1
Dust loading ISO 5011, at 100 mm depth

| Filter | Dust Loading Capacity (g) |
|---|---|
| Sample 1 | 1144 |
| Sample 2 | 1198 |
| Sample 3 | 1177 |
| Control | 1249 |

### Example 2

Various samples prepared using the same techniques as described in Example 1 were tested for chemical breakthrough.

The capacity of the filter media 100 to bind a target contaminant may be expressed in terms of a chemical breakthrough. In general, chemical breakthrough refers to the point at which a filter no longer effectively removes a target contaminant, thereby allowing the contaminant to pass through into the filtered output. This is typically expressed as a percentage of the inlet concentration of a contaminant that appears in the outlet stream. For example, a 1% breakthrough indicates a threshold of 1% of the contaminant present in the outlet when compared to the inlet. In other words, 1% of the contaminant present in the inlet is passing through the filter into the outlet. On the other hand, a 95% breakthrough occurs when 95% of the contaminant present in the inlet is passing through the filter into the outlet.

Acid Samples 1 and 3 were prepared using the same process as Example 1 (impregnated with 35% citric acid and 0.5% sodium benzoate). Basic Samples 1 and 3 were prepared using the same process as Example 1, except impregnated with a 17% potassium carbonate.

Samples 1 and 3 were tested according to ISO-11155-2 (2009).

TABLE 2
Chemical Breakthrough ISO 11155-2

| | | Time to 1% | Time to 95% |
|---|---|---|---|
| | | Breakthrough | Breakthrough |
| Contaminant | Filter | (mins) | (mins) |
| SO₂ | Base Sample 1 | 22 | 636 |
| | Base Sample 3 | — | — |
| NH₃ | Acid Sample 1 | 45 | 972 |
| | Acid Sample 3 | 3 | 680 |

It was observed that the filters impregnated with a base or acid are effective for removing an acidic or basic target contaminant.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A filter media comprising:
a single layer comprising fibers and an impregnate capable of binding a basic contaminant or an acidic contaminant, the impregnate being present at 5 g/m² or greater by area of the filter media;
the filter media having a dust filtration efficiency of 15% or greater as measured by ASTM F1215-89.

2. The filter media of claim 1, wherein the filter media has a dust filtration efficiency of 10% or greater for particles having an average particle size of 0.3 μm.

3. The filter media of claim 1, wherein the filter media further comprises a fluted sheet, a facing sheet, and a plurality of flutes formed between the fluted sheet and the facing sheet, wherein the plurality of flutes are closed to unfiltered air flowing into the filter media and the fluted sheet comprises repeating internal peaks facing toward the facing sheet and repeated external peaks facing away from the facing sheet.

4. The filter media of claim 1, wherein the filter media comprises fibers having a diameter of 0.1 μm or greater.

5. The filter media of claim 1, wherein the impregnate comprises sodium carbonate, sodium bicarbonate, potassium carbonate, potassium bicarbonate, calcium carbonate, calcium bicarbonate, sodium hydroxide, potassium hydroxide, calcium hydroxide, lithium hydroxide, sodium metabisulfite, potassium metabisulfite, metal oxides, sodium silicate, potassium silicate, quaternary ammonium salts and polymers containing quaternary ammonium salts, silica gel, zeolites, molecular sieves, aluminosilicates, ion-exchange resin, or a combination of two or more thereof.

6. The filter media of claim 1, wherein the impregnate comprises carboxylic acid, sulfonic acid, sulfuric acid, phosphoric acid, nitric acid, hydrochloric acid, heteropoly acid, a linear sulfonic acid, a cyclic sulfonic acid, an aromatic sulfonic acid, or a combination of two or more thereof.

7. The filter media of claim 1, wherein the impregnate is free of activated carbon.

8. The filter media of claim 1, wherein the impregnate is present in the filter media at 160 g/m² or less.

9. The filter media of claim 1, wherein the fibers of the filter media comprise cellulose fibers, synthetic fibers, glass fibers, or a combination of two or more thereof.

10. The filter media of claim 1, wherein the filter media has a basis weight in a range of 30 g/m² to 200 g/m².

11. The filter media of claim 1, comprising a laminated media comprising two or more of the first layer.

12. The filter media of claim 11, wherein the laminated media comprises a plurality of the first layer coupled via lamination.

13. The filter media of claim 12, wherein the lamination comprises an adhesive, optionally wherein the adhesive comprises a hot melt adhesive.

14. The filter media of claim 11, further comprising one or more of a second layer that is different from the first layer.

15. The filter media of claim 14, wherein the second layer is a separation layer.

16. The filter media of claim 15, wherein the second layer has a thickness of 0.15 mm or greater.

17. A filter element comprising:
a media pack having an inlet end and an outlet end, the media pack comprising:
a single layer comprising fibers and an impregnate capable of binding a basic contaminant or an acidic contaminant, the impregnate being present at 5 g/m² or greater by area of the media pack;
the media pack having a dust filtration efficiency of 15% or greater as measured by ASTM F1215-89.

18. The filter element of claim 17, wherein the media pack has a dust filtration efficiency of 10% or greater for particles having an average particle size of 0.3 μm.

19. The filter element of claim 17, wherein the media pack further comprises a fluted sheet, a facing sheet, and a plurality of flutes formed between the fluted sheet and the facing sheet, wherein the plurality of flutes are closed to unfiltered air flowing into the media pack and the fluted sheet comprises repeating internal peaks facing toward the facing sheet and repeated external peaks facing away from the facing sheet.

20. The filter element of claim 19, wherein the plurality of flutes has a round, obround, or rectangular shaped cross-section.
